(19) United States
(12) Patent Application Publication
(10) Pub. No.: US 2025/0162958 A1
(43) Pub. Date: May 22, 2025

(54) COMPOSITIONS COMPRISING ULTRAFINE BUBBLES AND METHODS OF USING THEREOF IN AGRICULTURE

(71) Applicant: Hydrosome IP, LLC, Westmont, IL (US)

(72) Inventors: Peter A. Kozak, Bolingbrook, IL (US); John Nicholas Jackowetz, Rochester, NY (US); Carly S. Hanson, Naperville, IL (US); Kiriako D. Tsoukalas, Munster, IN (US); Bob Jacobs, Newtown, CT (US); David C. Bom, Union, KY (US)

(21) Appl. No.: 18/945,984

(22) Filed: Nov. 13, 2024

Related U.S. Application Data
(60) Provisional application No. 63/599,686, filed on Nov. 16, 2023.

(51) Int. Cl. C05G 5/23; A01N 25/04; A01N 37/10; A01N 37/38; A01N 37/40; A01N 43/40; A01N 43/60; A01N 43/653; A01N 57/20; A01P 13/00; C05G 1/00

(52) U.S. Cl. CPC C05G 5/23; A01N 25/04; A01N 37/10; A01N 37/38; A01N 37/40; A01N 43/40; A01N 43/60; A01N 43/653; A01N 57/20; A01P 13/00; C05G 1/00

(57) ABSTRACT

The disclosure provides compositions including ultrafine bubbles. The ultrafine bubbles may include water and gases released from solution in the water. The compositions may also include at least one non-gaseous solute. The ultrafine bubbles of the compositions may dissolve, surround, and/or stabilize one or more non-gaseous solutes. Methods of making and using the compositions for agricultural applications are also provided.

### FIELD

The present disclosure generally relates to aqueous compositions that comprise soft cavitated water and/or ultrafine bubbles and/or non-gaseous solutes for use in agriculture.

### BACKGROUND

Delta-9-Tetrahydrocannabinol (THC) is the primary psychoactive compound found in cannabis plants (e.g., Cannabis sativa, Cannabis indica, Cannabis ruderalis, hybrids thereof). As a pharmaceutical compound, THC has been recognized for its medical uses as an appetite stimulant, an antiemetic, and agent for relief of sleep apnea. Increasing the THC potency and yield of cannabis plants has long been a goal of medicinal cannabis farmers, who expend significant resources on exploring experimental breeding crosses, genetic modifications of cannabis plants, and changes to cultivation processes to obtain strains of cannabis having ever-higher yields of THC. Even relatively modest increases in THC content (e.g., about 2-3% increase) over standard yields represents an enormous value to cannabis farmers. Increasing the potency and yield of other cannabinoids and bioactive compounds (such as terpenes) within cannabis plants is also of paramount importance to cannabis farmers.

Terpenes are bioactive molecules which have become the focus of medical research for their varied effects within the human body. Humulus lupus, or hops plants, are known for producing various terpenes. Hops farmers would therefore welcome the ability to substantially increase the potency and yield of terpenes within crops of hops.

However, existing strains of cannabis plants and hop plants are known to be temperamental with respect to root-based absorption of nutrients necessary for growth and production of the flowers that contain the desired THC, other cannabinoids, terpenes, and other bioactive compounds. Essential nutrients must be absorbed, in proper amounts, via the soil for a cannabis or hop plant to experience healthy growth. These essential nutrients include, but are not limited to, nitrogen (N), phosphorus (P), potassium (K), calcium (Ca), magnesium (Mg), sulfur (S), iron (Fe), manganese (Mn), zinc (Zn), copper (Cu), boron (B), molybdenum (Mo), and chlorine (Cl). Unfortunately, problems such as “nutrient lockout”, in which cannabis and hops plants struggle to absorb nutrients from the soil, and “fertilizer burn,” in which the plants suffer from over absorption of one or more nutrients, are common.

Thus, it would be beneficial to develop compositions and methods for improving efficient nutrient absorption in cannabis and hop plants to support the healthy growth necessary to increase the yield of bioactive compounds including, but not limited to, THC and terpenes. Additionally, it would be beneficial if such compositions and methods for increasing the yield of bioactives (e.g., THC, terpenes) could be used on existing strains of cannabis and hops plants and with standard cultivation techniques, without requiring time-consuming experimental cross-breeding to produce new high-bioactive yielding cannabis or hops plant hybrids, extensive changes to established cultivation techniques, or expensive genetic modification to cannabis or hops breeds.

Plants which are reproduced via artificial asexual propagation (e.g., vegetative propagation, cutting and clonal propagation) often experience significant die-off (approximately 15-20% mortality) or reduction in overall health following the cutting process and during rooting. Reducing die-off and improving the early health of these asexually propagated cuttings is of particular importance in increasing the yield of these vegetatively propagated species. Thus, it would be beneficial to develop compositions and methods for improving the overall health of artificially asexually reproduced plants (e.g., cannabis, tomatoes, hops, basil) following cutting and during rooting/vegetative regeneration to reduce die-off.

Plant material removed at harvest (e.g., cannabis flowers, basil leaves, dandelion leaves) often undergoes significant moisture loss and exhibits substantial wilting following harvest. The loss of moisture often results in undesirable loss of flavor or potency. Thus, it would be beneficial to develop compositions and methods for preventing or reducing moisture loss of plant materials following harvest thereof.

Curbing overuse of herbicides and limiting use of chemicals on lawns, gardens, and farms has become an environmental focus. While the need to reduce prevalence of unwanted vegetation persists, techniques for reducing the amount of herbicidal chemical necessary to achieve removal and/or reduction of unwanted weeds and other vegetation are necessary. Thus, it would be beneficial to develop more efficient compositions and methods for killing weeds and other unwanted plants, while substantially reducing the amount of herbicides and chemical compositions needed to do so.

### SUMMARY

The present disclosure provides compositions and methods for improving agricultural practices, the compositions or solutions including ultrafine bubbles. In some embodiments, the ultrafine bubbles are gaseous ultrafine bubbles (i.e., ultrafine bubbles that comprise or consist essentially of water and gases released from solution in the water and produced via gaseous or “soft” cavitation). In some embodiments, the compositions include at least one non-gaseous solute dissolved within, surrounded by, and/or stabilized by the ultrafine bubbles.

In some embodiments, the compositions and methods can be used to increase cannabis and hops bioactive compound yields and/or potency of cannabis and/or hops plant blooms (e.g., increasing THC and/or terpene content). The methods include applying compositions or solutions in accordance with the disclosure herein to actively growing female cannabis and/or hops plants.

In some embodiments, the compositions and methods can be used to improve extraction of live rosin from cannabis (e.g., improving yield from cold water extraction). The methods include using compositions or solutions in accordance with the disclosure herein to extract live rosin from cannabis flower blooms.

In other embodiments, the compositions and methods can be used to reduce die-off and increase overall health of plants being propagated via artificial asexual reproduction techniques—e.g., cutting and cloning methods. The methods include applying compositions or solutions in accordance with the disclosure herein to clonal cuttings during rooting after the cuttings are made.

In other embodiments, the compositions and methods can be used to reduce moisture loss and/or prevent wilting of harvested plant materials (e.g., cannabis plants, basil leaves, dandelion leaves). The methods include applying compositions or solutions in accordance with the disclosure herein to crop species prior to harvesting the plant materials.

In still other embodiments, the compositions and methods can be used to reduce the amount of herbicidal chemicals used for the purpose of removing or reducing unwanted weeds and vegetation—i.e., achieving the desired herbicidal effect while reducing the overall use of herbicides. The methods include applying compositions or solutions in accordance with the disclosure herein to unwanted weeds or plants, wherein the compositions comprise about 50% or less of the recommended concentrate of herbicide.

In some embodiments, the water is selected from DI water, ultrapure water, tap water, groundwater (e.g., well water), surface water, and reverse osmosis water. In particular embodiments, the water is ultrapure water. In particular embodiments, the water is DI water. In some embodiments, the water is tap water.

In some embodiments, the applied compositions include water having a population of ultrafine bubbles with a median ultrafine bubble diameter of between about 2-400 nanometers. In another embodiment, the ultrafine bubbles have a median diameter of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median diameter of between about 10 to about 15 nanometers, about 15 to about 20 nanometers, or about 20 to about 25 nanometers. In other embodiments, the ultrafine bubbles have a median diameter of between about 10 to about 50 nanometers, about 20 to about 50 nanometers, about 30 to about 50 nanometers, or about 40 to about 50 nanometers. In still other embodiments, the ultrafine bubbles have a median diameter of between about 50 to about 100 nanometers. In yet further embodiments, the ultrafine bubbles have a median diameter of between about 100 to about 200 nanometers, about 150 to about 200 nanometers, about 200 to about 300 nanometers, about 250 to about 300 nanometers, or about 300 to about 400 nanometers.

In some embodiments, the ultrafine bubbles are present in the composition at a concentration of up to 10¹⁰ ultrafine bubbles/mL, as measured via nanoparticle tracking analysis (NTA), which is able to detect bubbles with diameters of 50 to 1000 nanometers. In some embodiments, the ultrafine bubbles are present in the composition at a range of 10 to 10² ultrafine bubbles/mL, 10² to 10³ ultrafine bubbles/mL, 10³ to 10⁴ ultrafine bubbles/mL, 10⁴ to 10⁵ ultrafine bubbles/mL, 10⁵ to 10⁶ ultrafine bubbles/mL, 10⁶ to 10⁷ ultrafine bubbles/mL, 10⁷ to 10⁸ ultrafine bubbles/mL, 10⁸ to 10⁹ ultrafine bubbles/mL, or 10⁹ to 10¹⁰ ultrafine bubbles/mL.

In certain embodiments in which the water of the composition is enriched via microbubble generation prior to generation of the ultrafine bubbles in the composition, the concentration of ultrafine bubbles in the resulting composition may be higher. In such embodiments, the ultrafine bubbles may be present in the composition at a range of 10¹⁰ to 10¹¹ ultrafine bubbles/mL. In some embodiments, the ultrafine bubbles are present in the composition at a range of 10¹⁰ to 10¹¹ ultrafine bubbles/mL.

In some embodiments, the ultrafine bubbles remain stable within the composition for at least two years. In particular embodiments, the ultrafine bubbles remain stable within the composition for at least 2.5 years. In some embodiments, the ultrafine bubbles are concentrated within the composition via rotary evaporation and/or cross flow filtration. In particular embodiments, concentrated ultrafine bubbles are stable within the composition for at least 2 years.

In some embodiments, the compositions including ultrafine bubbles comprising or consisting essentially of water and gases released from solution in the water have improved bioavailability relative to naturally occurring water, and relative to compositions including ultrafine bubbles not formed via gaseous cavitation. In some embodiments, the ultrafine bubbles comprising or consisting essentially of water and gases released from solution in the water improve bioavailability of the water in the compositions by about 10%, about 20%, about 30%, about 40%, about 50%, about 60%, about 70%, about 80%, or about 90% relative to naturally occurring water, and/or relative to compositions including ultrafine bubbles not formed via gaseous cavitation. In further embodiments, the ultrafine bubbles comprising or consisting essentially of water and dissolved/surrounded/stabilized solutes improve bioavailability of the water by about 1%, about 2%, about 3%, about 4%, about 5%, about 6%, about 7%, about 8%, or about 9% relative to naturally occurring water, and/or relative to compositions including ultrafine bubbles not formed via gaseous cavitation.

In some embodiments, the water has an oxidative reduction potential from about −200 mV to about 800 mV (e.g., about −200 mV, about −195 mV, about −190 mV, about −185 mV, about −180 mV, about −175 mV, about −170 mV, about −165 mV, about −160 mV, about −155 mV, about −150 mV, about −145 mV, about −140 mV, about −135 mV, about −130 mV, about −125 mV, about −120 mV, about −115 mV, about −110 mV, about −105 mV, about −100 mV, about −95 mV, about −90 mV, about −85 mV, about −80 mV, about −75 mV, about −70 mV, about −65 mV, about −60 mV, about −55 mV, about −50 mV, about −45 mV, about −40 mV, about −35 mV, about −30 mV, about −25 mV, about −20 mV, about −15 mV, about −10 mV, about −5 mV, about 0 mV, about 5 mV, about 10 mV, about 15 mV, about 20 mV, about 25 mV, about 30 mV, about 35 mV, about 40 mV, about 45 mV, about 50 mV, about 55 mV, about 60 mV, about 65 mV, about 70 mV, about 75 mV, about 80 mV, about 85 mV, about 90 mV, about 95 mV, about 100 mV, about 105 mV, about 110 mV, about 115 mV, about 120 mV, about 125 mV, about 130 mV, about 135 mV, about 140 mV, about 145 mV, about 150 mV, about 155 mV, about 160 mV, about 165 mV, about 170 mV, about 175 mV, about 180 mV, about 185 mV, about 190 mV, about 195 mV, about 200 mV, about 205 mV, about 210 mV, about 215 mV, about 220 mV, about 225 mV, about 230 mV, about 235 mV, about 240 mV, about 245 mV, about 250 mV, about 255 mV, about 260 mV, about 265 mV, about 275 mV, about 280 mV, about 290 mV, about 295 mV, about 300 mV, about 305 mV, about 310 mV, 315 mV, 320 mV, 325 mV, 330 mV, 335 mV, 340 mV, 345 mV, 350 mV, 355 mV, 360 mV, 365 mV, 370 mV, 375 mV, 380 mV, 385 mV, 390 mV, 395 mV, 400 mV, 405 mV, 410 mV, 415 mV, 420 mV, 425 mV, 430 mV, 435 mV, 440 mV, 445 mV, 450 mV, 455 mV, 460 mV, 465 mV, 470 mV, 475 mV, 480 mV, 485 mV, 490 mV, 495 mV, 500 mV, 505 mV, 510 mV, 515 mV, 520 mV, 525 mV, 530 mV, 535 mV, 540 mV, 545 mV, 550 mV, 555 mV, 560 mV, 565 mV, 570 mV, 575 mV, 580 mV, 585 mV, 590 mV, 595 mV, about 600 mV, about 605 mV, about 610 mV, about 615 mV, about 620 mV, about 625 mV, about 630 mV, about 635 mV, about 640 mV, about 645 mV, about 650 mV, about 655 mV, about 660 mV, about 665 mV, about 670 mV, about 675 mV, about 680 mV, about 685 mV, about 690 mV, about 695 mV, about 700 mV, about 705 mV, about 710 mV, about 715 mV, about 720 mV, about 725 mV, about 730 mV, about 735 mV, about 740 mV, about 745 mV, about 750 mV, about 755 mV, about 760 mV, about 765 mV, about 770 mV, about 775 mV, about 780 mV, about 785 mV, about 790 mV, about 795 mV, or about 800 mV).

In some embodiments, the pH of the water is between about 4 to about 8 (e.g., about 4, about 5, about 6, about 7, or about 8). In some embodiments of each or any of the above- or below-mentioned embodiments, the water has a resistivity between about 17 to about 18.2 meg-ohm cm.

In some embodiments, the compositions comprise ultrafine bubbles comprising or consisting essentially of water and gases released from solution in water, wherein the ultrafine bubbles optionally dissolve, surround, and/or stabilize a non-gaseous solute, and wherein the composition has a zeta potential of between about absolute value 0 and 40. In further embodiments, the zeta potential of the composition is between about −40 mV to about 0 mV. In still further embodiments, the zeta potential of the composition is between about −40 mV to about −35 mV, about −35 mV to about −30 mV, about −30 mV to about −25 mV, about −25 mV to about −20 mV, about −20 mV to about −15 mV, about −15 mV to about −10 mV, about −10 mV to about −5 mV, about −5 mV to about 0 mV, about 0 mV to about 5 mV, about 5 mV to about 10 mV, about 10 mV to about 15 mV, about 15 mV to about 20 mV, about 20 mV to about 25 mV, about 25 mV to about 30 mV, about 30 mV to about 35 mV, or about 35 mV to about 40 mV. The inventors have surprisingly found that despite relatively low zeta potentials of the compositions (e.g., typical ultrafine bubble compositions have zeta potentials of around absolute value 30 mV, significantly higher than the absolute value zeta potentials of the compositions herein), the ultrafine bubble compositions according to the disclosure herein achieve superior stability results over ultrafine bubbles formed by alternative means with higher absolute value zeta potentials.

In some embodiments, the applied compositions include at least one non-gaseous solute. In further embodiments, the at least one non-gaseous solute is dissolved within, surrounded by, and/or stabilized by the ultrafine bubbles.

In some embodiments, the compositions and/or ultrafine bubbles are stable and/or exhibit biological efficacy for at least six months, for at least one year, for at least 2 years, for at least 3 years, for at least 4 years, or for at least 5 years.

In some embodiments, the composition increases cell permeability and/or bioavailability of the at least one non-gaseous solute. In some embodiments, the at least one non-gaseous solute is present at a concentration of 0.1-30% by weight of the composition. In particular embodiments, the at least one non-gaseous solute is present at a concentration of between about 0.1 to 0.5 wt % of the composition, about 0.5 to 1 wt % of the composition, about 1 to 3 wt % of the composition, about 3 to 5 wt % of the composition, about 5 to 8 wt % of the composition, about 8 to 10 wt % of the composition, about 10 to 15 wt % of the composition, about 15 to 20 wt % of the composition, about 20 to 25 wt % of the composition, about 25 to 30 wt % of the composition, about 0.1 wt % of the composition, about 0.5 wt % of the composition, about 1 wt % of the composition, about 3 wt % of the composition, about 5 wt % of the composition, about 8 wt % of the composition, about 10 wt % of the composition, about 12 wt % of the composition, about 15 wt % of the composition, about 18 wt % of the composition, about 20 wt % of the composition, about 23 wt % of the composition, about 25 wt % of the composition, about 28 wt % of the composition, or about 30 wt % of the composition.

In some embodiments, the at least one non-gaseous solute is present at a concentration of 0.1-1% by weight of the composition, 1-2% by weight of the composition, 2-3% by weight of the composition, 3-4% by weight of the composition, 4-5% by weight of the composition, 5-6% by weight of the composition, 6-7% by weight of the composition, 7-8% by weight of the composition, 8-9% by weight of the composition, 9-10% by weight of the composition, 10-11% by weight of the composition, 11-12% by weight of the composition, 12-13% by weight of the composition, 13-14% by weight of the composition, 14-15% by weight of the composition, 15-16% by weight of the composition, 16-17% by weight of the composition, 17-18% by weight of the composition, 18-19% by weight of the composition, 19-20% by weight of the composition, 20-21% by weight of the composition, 21-22% by weight of the composition, 22-23% by weight of the composition, 23-24% by weight of the composition, 24-25% by weight of the composition, 25-26% by weight of the composition, 26-27% by weight of the composition, 27-28% by weight of the composition, 28-29% by weight of the composition, or 29-30% by weight of the composition.

In some embodiments, the at least one non-gaseous solute is present at a low concentration of 0.1-10% by weight of the composition. In other embodiments, the at least one non-gaseous solute is present at a concentration of 0.1-0.5% by weight of the composition, 0.5-1% by weight of the composition, 1-1.5% by weight of the composition, 1.5-2% by weight of the composition, 2-2.5% by weight of the composition, 2.5-3% by weight of the composition, 3-3.5% by weight of the composition, 3.5-4% by weight of the composition, 4-4.5% by weight of the composition, 4.5-5% by weight of the composition, 5-5.5% by weight of the composition, 5.5-6% by weight of the composition, 6-6.5% by weight of the composition, 6.5-7% by weight of the composition, 7-7.5% by weight of the composition, 7.5-8% by weight of the composition, 8-8.5% by weight of the composition, 8.5-9% by weight of the composition, 9-9.5% by weight of the composition, or 9.5-10% by weight of the composition.

In some embodiments, the at least one non-gaseous solute is present at a medium concentration of 10-30% by weight of the composition. In other embodiments, the at least one non-gaseous solute is present at a concentration of 10-10.5% by weight of the composition, 10.5-11% by weight of the composition, 11-11.5% by weight of the composition, 11.5-12% by weight of the composition, 12-12.5% by weight of the composition, 12.5-13% by weight of the composition, 13-13.5% by weight of the composition, 13.5-14% by weight of the composition, 14-14.5% by weight of the composition, 14.5-15% by weight of the composition, 15-15.5% by weight of the composition, 15.5-16% by weight of the composition, 16-16.5% by weight of the composition, 16.5-17% by weight of the composition, 17-17.5% by weight of the composition, 17.5-18% by weight of the composition, 18-18.5% by weight of the composition, 18.5-19% by weight of the composition, 19-19.5% by weight of the composition, 19.5-20% by weight of the composition, 20-20.5% by weight of the composition, 20.5-21% by weight of the composition, 21-21.5% by weight of the composition, 21.5-22% by weight of the composition, 22-22.5% by weight of the composition, 22.5-23% by weight of the composition, 23-23.5% by weight of the composition, 23.5-24% by weight of the composition, 24-24.5% by weight of the composition, 24.5-25% by weight of the composition, 25-25.5% by weight of the composition, 25.5-26% by weight of the composition, 26-26.5% by weight of the composition, 26.5-27% by weight of the composition, 27-27.5% by weight of the composition, 27.5-28% by weight of the composition, 28-28.5% by weight of the composition, 28.5-29% by weight of the composition, 29-29.5% by weight of the composition, or 29.5-30% by weight of the composition.

In certain embodiments, the non-gaseous solute is a nutrient important or essential for cannabis and/or hops growth and/or bioactive production. In particular embodiments, the nutrient important for or essential for cannabis and/or hops growth and/or bioactive production comprises or consists essentially of nitrogen, phosphorous, potassium, calcium, magnesium, ammonium, sulfur, copper, iron, manganese, molybdenum, zinc, boron, silicon, cobalt, vanadium and/or urea.

In certain embodiments, the non-gaseous solute is a nutrient important or essential for fungal growth and/or bioactive production. In particular embodiments, the nutrient important for or essential for fungal growth and/or bioactive production comprises or consists essentially of carbon, nitrogen, phosphorous, potassium, calcium, magnesium, ammonium, sulfur, copper, iron, manganese, molybdenum, zinc, boron, silicon, cobalt, vanadium and/or urea.

In certain embodiments, the non-gaseous solute is one or more nutrients important or essential for vegetative propagation after cutting (e.g., a nutrient that is necessary to induce rooting in a clonal cutting). In particular embodiments, a nutrient important or essential for vegetative propagation after cutting includes indole-3-butyric acid (IBA), naphthaleneacetic acid (NAA), and combinations thereof. In particular embodiments, a nutrient important or essential for vegetative propagation after cutting includes N, P, K, Ca, Mg, S, Fe, Mn, Zn, Cu, Mo, B, Cl, Si, and combinations thereof. In certain embodiments, a nutrient important or essential for vegetative propagation after cutting includes one or more beneficial microbes.

In other embodiments, the non-gaseous solute is one or more compounds which assist in reducing moisture loss, retaining water content, and/or preventing wilting of harvested plant materials (e.g., cannabis plants, basil leaves, dandelion leaves). In some embodiments, the one or more compounds includes an ethylene inhibitor.

In still other embodiments, the non-gaseous solute is one or more herbicidal chemicals/compounds used for the purpose of removing or reducing unwanted weeds and vegetation. In particular embodiments, the herbicidal chemicals/compounds include one or more of diquat dibromide, fluazifop-p-butyl, dicamba, dimethylamine salt, 2,4-D, dimethylamine salt, mecoprop-p, dimethylamine salt, glyphosate, and sulfentrazone

In some embodiments, the compositions comprise at least one non-gaseous solute (e.g., a solute dissolved within the composition). In further embodiments, the at least one non-gaseous solute is dissolved within, surrounded by, or stabilized by the ultrafine bubbles. In particular embodiments, the composition increases cell permeability and/or bioavailability of the at least one dissolved non-gaseous solute. In some embodiments, the at least one non-gaseous solute dissolved within or stabilized by the ultrafine bubbles has improved bioavailability relative to a solute not dissolved within or stabilized by the ultrafine bubbles. In further embodiments the at least one non-gaseous solute dissolved within or stabilized by the ultrafine bubbles has improved stability relative to a solute not dissolved within or stabilized by the ultrafine bubbles. In still further embodiments, the at least one non-gaseous solute dissolved within or stabilized by the ultrafine bubbles has improved solubility relative to a solute not dissolved within or stabilized by the ultrafine bubbles.

In some embodiments, the composition is used to deliver the at least one non-gaseous solute to a cell (e.g., the interior of the cell). In some embodiments, the cell is a fungal cell. In some embodiments, the cell is a plant cell. In particular embodiments, the plant cell is a cell of a cannabis plant. In some embodiments, the plant cell is a cell of a hops plant. In some embodiments, the plant cell is a cell of a basil plant. In some embodiments, the plant cell is a cell of a tomato plant. In some embodiments, the plant cell is a cell of a dandelion plant. In some embodiments, the plant cell is a cell of an unwanted pest plant or weed.

In some embodiments of each or any of the above- or below-mentioned embodiments, the composition is used for an agricultural application. The present disclosure also provides a composition that includes ultrafine bubbles and water. The ultrafine bubbles may have a median ultrafine bubble diameter of between about 2 to about 400 nanometers. The compositions may include a non-gaseous solute, and the ultrafine bubbles optionally dissolve, surround, and/or stabilize the non-gaseous solute.

The present disclosure also provides a composition that includes ultrafine bubbles comprising or consisting essentially of water and gases released from solution in the water. The ultrafine bubbles may have a median ultrafine bubble diameter of between about 2 to about 400 nanometers. In some embodiments, the ultrafine bubbles dissolve, surround, and/or stabilize a non-gaseous solute.

In some embodiments, the ultrafine bubbles have a median size of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median size of between about 10 to about 20 nanometers or about 15 to about 20 nanometers, or about 20 to about 25 nanometers. In other embodiments, the ultrafine bubbles have a median size of between about 10 to about 50 nanometers, about 20 to about 50 nanometers, about 30 to about 50 nanometers, or about 40 to about 50 nanometers. In still other embodiments, the ultrafine bubbles have a median size of between about 50 to about 100 nanometers. In yet further embodiments, the ultrafine bubbles have a median size of between about 100 to about 200 nanometers, about 150 to about 200 nanometers, about 200 to about 300 nanometers, about 250 to about 300 nanometers, or about 300 to about 400 nanometers.

In some embodiments, the composition is used for fertilizer or plant nutrient delivery, soil or plant hydration, fungal growth support, support of asexual plant propagation, heat tolerance, moisture retention, increasing bioactive yield, or seed germination. In some embodiments of each or any of the above- or below-mentioned embodiments, the composition is used to deliver at least one non-gaseous solute to the interior of a cell (e.g., a plant cell). In an embodiment of each or any of the above- or below-mentioned embodiments, the at least one non-gaseous solute dissolved within or stabilized by the ultrafine bubbles comprises a fertilizer or plant nutrient. In some embodiments, the composition includes ultrafine bubbles comprising or consisting essentially of water and gases released from solution in the water, wherein the ultrafine bubbles dissolve, surround, and/or stabilize the at least one non-gaseous solute (e.g., fertilizer and/or plant nutrient). In certain embodiments, the non-gaseous solute comprises indole-3-butyric acid (IBA), naphthaleneacetic acid (NAA), N, P, K, Ca, Mg, S, Fe, Mn, Zn, Cu, Mo, B, Cl, Si, ammonium, cobalt, vanadium, urea, ethylene inhibitors, and one or more beneficial microbes.

In some embodiments, the composition is used for herbicide delivery. In some embodiments of each or any of the above- or below-mentioned embodiments, the composition is used to deliver at least one non-gaseous solute to the interior of a cell (e.g., a plant cell). In an embodiment of each or any of the above- or below-mentioned embodiments, the at least one non-gaseous solute dissolved within or stabilized by the ultrafine bubbles comprises an herbicidal agent or compound. In some embodiments, the composition includes ultrafine bubbles comprising or consisting essentially of water and gases released from solution in the water, wherein the ultrafine bubbles dissolve, surround, and/or stabilize the at least one non-gaseous solute (e.g., herbicidal agent and/or compound). In certain embodiments, the non-gaseous solute comprises a commercial herbicide. In other embodiments, the non-gaseous solute comprises one or more of diquat dibromide; fluazifop-p-butyl; dicamba, dimethylamine salt; 2,4-D, dimethylamine salt; mecoprop-p, dimethylamine salt; glyphosate; and sulfentrazone.

In some embodiments, a composition according to the disclosure herein is used for live rosin extraction from cannabis blooms. In some embodiments of each or any of the above- or below-mentioned embodiments, the composition is used during extraction to mix with cannabis flower blooms and then agitated with the flower blooms to separate trichomes (which include cannabinoids and terpenes for concentration within the live rosin) from the vegetative material of the flower blooms. In some embodiments, the composition includes ultrafine bubbles comprising or consisting essentially of water and gases released from solution in the water. A non-gaseous solute is optionally included in the composition. The ultrafine bubbles optionally dissolve, surround, and/or stabilize the at least one non-gaseous solute (e.g., fertilizer and/or plant nutrient).

In another aspect of the invention disclosed herein, a method for producing a composition comprising water and ultrafine bubbles including gases released from solution in the water is provided. In some embodiments, the ultrafine bubbles are at a concentration of up to 10¹⁰ ultrafine bubbles/mL. In some embodiments, the ultrafine bubbles are at a concentration of up to 10¹¹ ultrafine bubbles/mL. The method includes subjecting water to a combination of hydrodynamic cavitation, shear forces, and thin film boiling to produce ultrafine bubbles formed by release of dissolved gases from the water. In some embodiments, the water is selected from DI water, ultrapure water, tap water, groundwater (e.g., well water), surface water, and reverse osmosis water. In particular embodiments, the water is ultrapure water. In other embodiments, the water is tap water. In some embodiments, the ultrafine bubbles are present in the composition at a range of 10 to 10² ultrafine bubbles/mL, 10² to 10³ ultrafine bubbles/mL, 10³ to 10⁴ ultrafine bubbles/mL, 10⁴ to 10⁵ ultrafine bubbles/mL, 10⁵ to 10⁶ ultrafine bubbles/mL, 10⁶ to 10⁷ ultrafine bubbles/mL, 10⁷ to 10⁸ ultrafine bubbles/mL, 10⁸ to 10⁹ ultrafine bubbles/mL, 10⁹ to 10¹⁰ ultrafine bubbles/mL, or 10¹⁰ to 10¹¹ ultrafine bubbles/mL.

In an embodiment of the method, the method further comprises dissolving at least one non-gaseous solute into the composition. In some embodiments, the at least one non-gaseous solute is dissolved within, surrounded by, and/or stabilized by the ultrafine bubbles.

In an embodiment of each or any of the above- or below-mentioned embodiments, the at least one non-gaseous solute dissolved within, surrounded by, and/or stabilized by the ultrafine bubbles comprises a fertilizer, fungal nutrient, or plant nutrient.

In an embodiment of each or any of the above- or below-mentioned embodiments, the at least one non-gaseous solute dissolved within, surrounded by, and/or stabilized by the ultrafine bubbles comprises a fungal nutrient.

In other embodiments, the at least one non-gaseous solute dissolved within, surrounded by, and/or stabilized by the ultrafine bubbles comprises an herbicidal agent or compound.

In some embodiments, the methods further comprise concentrating the ultrafine bubbles within the composition via rotary evaporation or cross flow filtration.

In some embodiments of the methods set forth herein, the bioactive yield (e.g., THC, other cannabinoids, terpenes) is increased by at least 2 wt % in cannabis blooms yielded by growing female cannabis plants to which compositions in accordance with the disclosure are applied as compared to the bioactives yielded by growing female cannabis plants of the same strain to which the disclosed compositions were not applied. In some embodiments, the composition is applied to the growing female cannabis plant during a flowering/fruiting/blooming stage. In other embodiments, the composition is applied to the growing female cannabis plant during a vegetative phase. In another embodiment, the composition is applied to the growing female cannabis plants during a seed germination phase. In yet still other embodiments, the composition is applied to the growing female cannabis plant during a clone propagation phase. In particular embodiments thereof, the growing female cannabis plants are grown via hydroponic technique during at least part of the clone propagation phase. In particular embodiments, the composition is applied to the growing female cannabis plant during the clone propagation phase in which the growing female cannabis plant is being grown via hydroponic technique.

In some embodiments, the roots of the growing female cannabis plant absorb the one or more solutes dissolved within, surrounded by, and/or stabilized by the ultrafine bubbles more efficiently as compared to a composition lacking the ultrafine bubbles. In some embodiments, the one or more of the dissolved and/or stabilized solutes in the composition includes a Nitrogen-Phosphorus-Potassium (NPK) fertilizer. Depending on the stage at which stage of growth the composition is applied to the growing female cannabis plant (e.g., seedling stage, vegetative stage, or flowering/blooming stage), the ratio of Nitrogen to Phosphorus to Potassium as solutes within the composition may change, as indicated in Table 1 below.

TABLE 1
NPK fertilizer ratios and amounts in compositions
for cannabis growth at different growth stages

| Growth | NPK | N | P | K |
|---|---|---|---|---|
| Stage | Ratio | (mg/L) | (mg/L) | (mg/L) |
| Seedling | 15-5-10 | 150 | 50 | 100 |
| Vegetative | 20-10-10 | 200 | 100 | 100 |
| Flowering | 10-20-30 | 100 | 200 | 300 |

In certain embodiments, compositions according to the disclosure herein include NPK fertilizer as a solute in which the ratio of Nitrogen:Phosphorus:Potassium is about 15:5:10 such that nitrogen is present within the composition at about 150 mg/L, phosphorus is present within the composition at about 50 mg/L, and potassium is present at about 100 mg/L. In particular embodiments, the composition with about 15:5:10 N:P:K ratio is applied to growing cannabis plants at the seedling stage in an amount of about 0.2 gallons per seedling per day.

In certain embodiments, compositions according to the disclosure herein include NPK fertilizer as a solute in which the ratio of Nitrogen:Phosphorus:Potassium is about 20:10:10 such that nitrogen is present within the composition at about 200 mg/L, phosphorus is present within the composition at about 100 mg/L, and potassium is present at about 100 mg/L. In particular embodiments, the composition with about 20:10:10 N:P:K ratio is applied to growing cannabis plants at the vegetative stage in an amount of about 0.35 gallons per vegetative plant per day.

In certain embodiments, compositions according to the disclosure herein include NPK fertilizer as a solute in which the ratio of Nitrogen:Phosphorus:Potassium is about 10:20:30 such that nitrogen is present within the composition at about 100 mg/L, phosphorus is present within the composition at about 200 mg/L, and potassium is present at about 300 mg/L. In particular embodiments, the composition with about 10:20:30 N:P:K ratio is applied to growing cannabis plants at the blooming/flowering stage in an amount of about 1 gallon per flowering plant per day.

In some embodiments of the methods set forth herein, the bioactive yield (e.g., terpenes) is increased by at least 2 wt % in hops blooms yielded by growing female hops plants to which the disclosed compositions are applied as compared to hops blooms yielded by growing female hops plants of the same strain to which the disclosed compositions were not applied. In some embodiments, the composition is applied to the growing female hops plant during a flowering/fruiting/blooming stage. In other embodiments, the composition is applied to the growing female hops plant during a vegetative phase. In another embodiment, the composition is applied to the growing female hops plants during a seed germination phase. In yet still other embodiments, the composition is applied to the growing female hops plant during a clone propagation phase. In particular embodiments thereof, the growing female hops plants are grown via hydroponic technique during at least part of the clone propagation phase. In particular embodiments, the composition is applied to the growing female hops plant during the clone propagation phase in which the growing female hops plant is being grown via hydroponic technique.

In some embodiments, the roots of the growing female hops plant absorb the one or more solutes dissolved within, surrounded by, and/or stabilized by the ultrafine bubbles more efficiently as compared to a composition lacking the ultrafine bubbles. In some embodiments, one or more of the dissolved and/or stabilized solutes is present at a concentration of 10 to 250 mg/L of water having the population of ultrafine bubbles. In some embodiments, the one or more dissolved, surrounded, and/or stabilized solutes includes nitrogen present at a concentration between about 40 to 120 mg/L of water having the population of ultrafine bubbles. In some embodiments, the one or more dissolved, surrounded, and/or stabilized solutes includes phosphorus present at a concentration between about 40 to 120 mg/L of water having the population of ultrafine bubbles. In some embodiments, the one or more dissolved, surrounded, and/or stabilized solutes includes potassium present at a concentration between about 100 to 220 mg/L of water having the population of ultrafine bubbles.

In some embodiments of the methods set forth herein, the bioactive yield (e.g., psilocybin, psilocin, baeocystin, norbaeocystin, other psychoactives) is increased by at least 2 wt % in fungal species yielded by growing the fungal species (e.g., mushrooms) to which compositions in accordance with the disclosure are applied as compared to the bioactives yielded by growing the same fungal species to which the disclosed compositions were not applied. In some embodiments, the fungal species is one or more species of mushrooms belonging to the genus Psilocybe or to the genus Genera. In some embodiments, the one or more species of mushrooms include, but are not limited to: Psilocybe cubensis, Psilocybe semilanceata, Psilocybe cyanescens, Psilocybe azurescens, Psilocybe baeocystis, Psilocybe pelliculosa, Psilocybe mexicana, Psilocybe tampanensis, Psilocybe caerulescens, and Gymnopilus spp. (including Gymnopilus spectabilis).

In some embodiments of the methods set forth herein, the survivability of artificially asexually propagated plants (e.g., those propagated using cloning/cutting techniques) is improved and/or die-off of these plants is reduced. The methods disclosed herein may reduce die-off of clones in the rooting stage after cutting from an average of 15%-25% die-off to 5-10% die-off, representing a substantial increase in number of viable plants. In some embodiments, clonal cuttings to which the disclosed compositions are applied demonstrate increased overall health (and/or survivability) as compared to clonal cuttings of the same strain to which the disclosed compositions were not applied. In some embodiments, the composition is applied to the growing female hops plant during a clone propagation phase. In particular embodiments, the composition is applied to a clonal cutting following the cutting itself during a regenerative stage/rooting stage.

In some embodiments, the cut portion of the clonal cuttings absorbs the one or more solutes dissolved within, surrounded by, and/or stabilized by the ultrafine bubbles more efficiently as compared to a composition lacking the ultrafine bubbles. In some embodiments, one or more of the dissolved and/or stabilized solutes is present at a concentration of 1 to 15 mg/L of water having the population of ultrafine bubbles. In some embodiments, the one or more dissolved, surrounded, and/or stabilized solutes includes nitrogen present at a concentration between about 0.1 to 5 mg/L of water having the population of ultrafine bubbles. In some embodiments, the one or more dissolved, surrounded, and/or stabilized solutes includes phosphorus present at a concentration between about 0.5 to 6 mg/L of water having the population of ultrafine bubbles. In some embodiments, the one or more dissolved, surrounded, and/or stabilized solutes includes potassium present at a concentration between about 0.1 to 5 mg/L of water having the population of ultrafine bubbles.

In some embodiments of the methods set forth herein, the capacity of harvested plant materials (e.g., leaves, flowers) to retain moisture is increased by at least 5 wt % in plants to which the disclosed compositions are applied as compared to harvested plant materials yielded by plants of the same variety to which the disclosed compositions were not applied. In some embodiments, the composition is applied to the growing plant during a flowering/fruiting/blooming stage. In other embodiments, the composition is applied to the growing plant during a vegetative phase. In another embodiment, the composition is applied to the growing plant during a seed germination phase. In yet still other embodiments, the composition is applied to the growing plant during a clone propagation phase. In particular embodiments thereof, the growing plants are grown via hydroponic technique during at least part of the clone propagation phase. In particular embodiments, the composition is applied to the growing plant during the clone propagation phase in which the growing plant is being grown via hydroponic technique.

In some embodiments, the growing plants and/or fungi absorb the one or more solutes dissolved within, surrounded by, and/or stabilized by the ultrafine bubbles more efficiently as compared to a composition lacking the ultrafine bubbles. In some embodiments, one or more of the dissolved and/or stabilized solutes is present at a concentration between about 180 to 460 mg/L of water having the population of ultrafine bubbles. In some embodiments, the one or more dissolved, surrounded, and/or stabilized solutes includes nitrogen present at a concentration between about 40 to 120 mg/L of water having the population of ultrafine bubbles. In some embodiments, the one or more dissolved, surrounded, and/or stabilized solutes includes phosphorus present at a concentration between about 40 to 120 mg/L of water having the population of ultrafine bubbles. In some embodiments, the one or more dissolved, surrounded, and/or stabilized solutes includes potassium present at a concentration between about 100 to 220 mg/L of water having the population of ultrafine bubbles.

In some embodiments of the methods set forth herein, the efficacy of herbicidal regimens is increased; that is, compositions in accordance with the disclosure are used to increase the efficacy of herbicidal regimens. In particular embodiments, the concentration of herbicide used in the compositions may be halved or even further reduced from the amounts recommended for use in compositions/solutions not produced in accordance with the disclosure, yet still achieve desirable herbicidal effect (including the same or better results than that of the same herbicides applied in conventional amounts). In some embodiments, the growing plants absorb the one or more solutes (e.g., herbicidal compounds or agents) dissolved within, surrounded by, and/or stabilized by the ultrafine bubbles more efficiently as compared to a composition lacking the ultrafine bubbles.

In some embodiments, the ultrafine bubbles comprise about 25, about 30, about 35, about 40, about 45, about 50, about 75, about 100, about 125, about 150, about 175, about 200, about 225, about 250, about 275, about 300, about 325, about 350, about 375, about 400, about 425, about 450, about 475, or about 500 water molecules.

In some embodiments, the ultrafine bubbles have a median size (diameter) of between about 2 to about 400 nanometers. In another embodiment, the ultrafine bubbles have a median size of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median size of between about 10 to about 15 nanometers or about 15 to about 20 nanometers, or about 20 to about 25 nanometers. In other embodiments, the ultrafine bubbles have a median size of between about 10 to about 50 nanometers, about 20 to about 50 nanometers, about 30 to about 50 nanometers, or about 40 to about 50 nanometers. In still other embodiments, the ultrafine bubbles have a median size of between about 50 to about 100 nanometers. In yet further embodiments, the ultrafine bubbles have a median size of between about 100 to about 200 nanometers, about 150 to about 200 nanometers, about 200 to about 300 nanometers, about 250 to about 300 nanometers, or about 300 to about 400 nanometers.

In an embodiment, the solute dissolved within, surrounded by, and/or stabilized by the ultrafine bubbles is a nutrient important or necessary for cannabis and/or hops growth. In certain embodiments, the nutrient comprises nitrogen, phosphorous, potassium, calcium, magnesium, ammonium, sulfur, copper, iron, manganese, molybdenum, zinc, boron, silicon, cobalt, vanadium and/or urea. In some embodiments, the nutrient/solute has improved bioavailability and increased root-based absorption relative to nutrient/solute which has not been dissolved within, surrounded by, and/or stabilized by ultrafine bubbles. In further embodiments, the solute/nutrient dissolved within, surrounded by, and/or stabilized by ultrafine bubbles has improved stability relative to a nutrient/solute which has not been dissolved within, surrounded by, and/or stabilized by ultrafine bubbles. In still further embodiments, the solute dissolved within, surrounded by, and/or stabilized by ultrafine bubbles has improved solubility relative to a nutrient/solute which has not been dissolved within, surrounded by, and/or stabilized by ultrafine bubbles. In still other embodiments, the solute dissolved within, surrounded by, and/or stabilized by ultrafine bubbles improves root-based absorption and cannabis and/or hops plant growth and development.

In an embodiment, the solute dissolved within, surrounded by, and/or stabilized by the ultrafine bubbles is a nutrient necessary or important for fungal growth and/or bioactive production. In certain embodiments, the nutrient comprises carbon, nitrogen, phosphorous, potassium, calcium, magnesium, ammonium, sulfur, copper, iron, manganese, molybdenum, zinc, boron, silicon, cobalt, vanadium and/or urea. In some embodiments, the nutrient/solute has improved bioavailability and increased mycelia/hyphae-based absorption relative to nutrient/solute which has not been dissolved within, surrounded by, and/or stabilized by ultrafine bubbles. In further embodiments, the solute/nutrient dissolved within, surrounded by, and/or stabilized by ultrafine bubbles has improved stability relative to a nutrient/solute which has not been dissolved within, surrounded by, and/or stabilized by ultrafine bubbles. In still further embodiments, the solute dissolved within, surrounded by, and/or stabilized by ultrafine bubbles has improved solubility relative to a nutrient/solute which has not been dissolved within, surrounded by, and/or stabilized by ultrafine bubbles. In still other embodiments, the solute dissolved within, surrounded by, and/or stabilized by ultrafine bubbles improves mycelia/hyphae-based absorption and fungal/mushroom growth and development.

In an embodiment, the solute dissolved within, surrounded by, and/or stabilized by the ultrafine bubbles is a nutrient necessary for artificial asexual propagation of plants. In certain embodiments, the nutrient comprises nitrogen, phosphorous, potassium, calcium, magnesium, ammonium, sulfur, copper, iron, manganese, molybdenum, zinc, boron, silicon, cobalt, vanadium and/or urea. In some embodiments, the nutrient/solute has improved bioavailability and increased absorption relative to nutrient/solute which has not been dissolved within, surrounded by, and/or stabilized by ultrafine bubbles. In further embodiments, the solute/nutrient dissolved within, surrounded by, and/or stabilized by ultrafine bubbles has improved stability relative to a nutrient/solute which has not been dissolved within, surrounded by, and/or stabilized by ultrafine bubbles. In still further embodiments, the solute dissolved within, surrounded by, and/or stabilized by ultrafine bubbles has improved solubility relative to a nutrient/solute which has not been dissolved within, surrounded by, and/or stabilized by ultrafine bubbles. In still other embodiments, the solute dissolved within, surrounded by, and/or stabilized by ultrafine bubbles improves clone root development. In other embodiments, the solute dissolved within, surrounded by, and/or stabilized by ultrafine bubbles reduces clone die-off.

In an embodiment, the solute dissolved within, surrounded by, and/or stabilized by the ultrafine bubbles is a compound or agent useful for enabling plant materials to retain moisture even after removal from the plant itself (e.g., harvested plant materials). In certain embodiments, the compound or agent comprises nitrogen, phosphorous, potassium, calcium, magnesium, ammonium, sulfur, copper, iron, manganese, molybdenum, zinc, boron, silicon, cobalt, vanadium urea, and/or ethylene inhibitors. In some embodiments, the compound or agent has improved bioavailability and increased root-based absorption relative to compound or agent which has not been dissolved within, surrounded by, and/or stabilized by ultrafine bubbles. In further embodiments, the compound or agent dissolved within, surrounded by, and/or stabilized by ultrafine bubbles has improved stability relative to a compound or agent which has not been dissolved within, surrounded by, and/or stabilized by ultrafine bubbles. In still further embodiments, the compound or agent dissolved within, surrounded by, and/or stabilized by ultrafine bubbles has improved solubility relative to a compound or agent which has not been dissolved within, surrounded by, and/or stabilized by ultrafine bubbles. In still other embodiments, the compound or agent dissolved within, surrounded by, and/or stabilized by ultrafine bubbles reduces moisture loss of harvested plant materials (e.g., basil leaves, cannabis flowers, dandelion leaves). In still other embodiments, the compound or agent dissolved within, surrounded by, and/or stabilized by ultrafine bubbles reduces wilting of harvested plant materials (e.g., basil leaves, cannabis flowers, dandelion leaves).

In an embodiment, the solute dissolved within, surrounded by, and/or stabilized by the ultrafine bubbles is an herbicidal compound or agent useful for destruction of unwanted plants. In certain embodiments, the compound or agent comprises diquat dibromide; fluazifop-p-butyl; dicamba, dimethylamine salt; 2,4-D, dimethylamine salt; mecoprop-p, dimethylamine salt; glyphosate; and/or sulfentrazone. In some embodiments, the compound or agent has improved bioavailability and increased root-based absorption relative to compound or agent which has not been dissolved within, surrounded by, and/or stabilized by ultrafine bubbles. In further embodiments, the compound or agent dissolved within, surrounded by, and/or stabilized by ultrafine bubbles has improved stability relative to a compound or agent which has not been dissolved within, surrounded by, and/or stabilized by ultrafine bubbles. In still further embodiments, the compound or agent dissolved within, surrounded by, and/or stabilized by ultrafine bubbles has improved solubility relative to a compound or agent which has not been dissolved within, surrounded by, and/or stabilized by ultrafine bubbles. In still other embodiments, the compound or agent dissolved within, surrounded by, and/or stabilized by ultrafine bubbles increases plant mortality compared to the same compound or agent not dissolved within, surrounded by, and/or stabilized by the ultrafine bubbles.

In certain embodiments, the methods further include preparing the compositions used by pumping the water and the one or more non-gaseous solutes through a transfer pipe and a nozzle into a hollow cylinder, wherein the nozzle is located at the proximal end of the hollow cylinder. The nozzle includes an intake hole in a proximal face of the nozzle connected to the transfer pipe and one or more jet openings in a distal face of the nozzle that open into a chamber defined by the hollow cylinder. The water passing through the one or more jet openings creates a vortex of water in contact with an inner surface of the chamber. The compositions exit the hollow cylinder (containing ultrafine bubbles and the one or more non-gaseous solutes as disclosed), such that the one or more non-gaseous solutes is dissolved within, surrounded by, and/or stabilized by the ultrafine bubbles in accordance with the disclosure.

In other embodiments, the methods further include preparing the compositions used by pumping the water through a transfer pipe and a nozzle into a hollow cylinder, wherein the nozzle is located at the proximal end of the hollow cylinder. The nozzle includes an intake hole in a proximal face of the nozzle connected to the transfer pipe and one or more jet openings in a distal face of the nozzle that open into a chamber defined by the hollow cylinder. The water passing through the one or more jet openings creates a vortex of water in contact with an inner surface of the chamber. The pumped water exits the hollow cylinder (containing ultrafine bubbles as disclosed) as composition water with ultrafine bubbles. After the water with ultrafine bubbles exits, optionally one or more non-gaseous solutes is mixed into the exited water to produce a composition in which the one or more non-gaseous solutes is dissolved within, surrounded by, and/or stabilized by ultrafine bubbles in accordance with this disclosure.

In an embodiment, the solute dissolved within and/or stabilized by an ultrafine bubble comprises a fertilizer and/or plant/fungal nutrient. In some embodiments, the solute dissolved within and/or stabilized by an ultrafine bubble comprises an agent or compound helpful for increasing a plant's ability to retain moisture. In some embodiments, the solute dissolved within and/or stabilized by an ultrafine bubble comprises an herbicidal agent or compound.

In some embodiments of each or any of the above- or below-mentioned embodiments, the ultrafine bubbles comprise or consist essentially of ultrapure water having an oxidative reduction potential about −200 to about 800 mV (e.g., from about −200 mV to about 800 mV (e.g., about −200 mV, about −195 mV, about −190 mV, about −185 mV, about −180 mV, about −175 mV, about −170 mV, about −165 mV, about −160 mV, about −155 mV, about −150 mV, about −145 mV, about −140 mV, about −135 mV, about −130 mV, about −125 mV, about −120 mV, about −115 mV, about −110 mV, about −105 mV, about −100 mV, about −95 mV, about −90 mV, about −85 mV, about −80 mV, about −75 mV, about −70 mV, about −65 mV, about −60 mV, about −55 mV, about −50 mV, about −45 mV, about −40 mV, about −35 mV, about −30 mV, about −25 mV, about −20 mV, about −15 mV, about −10 mV, about −5 mV, about 0 mV, about 5 mV, about 10 mV, about 15 mV, about 20 mV, about 25 mV, about 30 mV, about 35 mV, about 40 mV, about 45 mV, about 50 mV, about 55 mV, about 60 mV, about 65 mV, about 70 mV, about 75 mV, about 80 mV, about 85 mV, about 90 mV, about 95 mV, about 100 mV, about 105 mV, about 110 mV, about 115 mV, about 120 mV, about 125 mV, about 130 mV, about 135 mV, about 140 mV, about 145 mV, about 150 mV, about 155 mV, about 160 mV, about 165 mV, about 170 mV, about 175 mV, about 180 mV, about 185 mV, about 190 mV, about 195 mV, or about 200 mV, about 205 mV, about 210 mV, about 215 mV, about 220 mV, about 225 mV, about 230 mV, about 235 mV, about 240 mV, about 245 mV, about 250 mV, about 255 mV, about 260 mV, about 265 mV, about 275 mV, about 280 mV, about 290 mV, about 295 mV, about 300 mV, about 305 mV, about 310 mV, 315 mV, 320 mV, 325 mV, 330 mV, 335 mV, 340 mV, 345 mV, 350 mV, 355 mV, 360 mV, 365 mV, 370 mV, 375 mV, 380 mV, 385 mV, 390 mV, 395 mV, 400 mV, 405 mV, 410 mV, 415 mV, 420 mV, 425 mV, 430 mV, 435 mV, 440 mV, 445 mV, 450 mV, 455 mV, 460 mV, 465 mV, 470 mV, 475 mV, 480 mV, 485 mV, 490 mV, 495 mV, 500 mV, 505 mV, 510 mV, 515 mV, 520 mV, 525 mV, 530 mV, 535 mV, 540 mV, 545 mV, 550 mV, 555 mV, 560 mV, 565 mV, 570 mV, 575 mV, 580 mV, 585 mV, 590 mV, 595 mV, about 600 mV, about 605 mV, about 610 mV, about 615 mV, about 620 mV, about 625 mV, about 630 mV, about 635 mV, about 640 mV, about 645 mV, about 650 mV, about 655 mV, about 660 mV, about 665 mV, about 670 mV, about 675 mV, about 680 mV, about 685 mV, about 690 mV, about 695 mV, about 700 mV, about 705 mV, about 710 mV, about 715 mV, about 720 mV, about 725 mV, about 730 mV, about 735 mV, about 740 mV, about 745 mV, about 750 mV, about 755 mV, about 760 mV, about 765 mV, about 770 mV, about 775 mV, about 780 mV, about 785 mV, about 790 mV, about 795 mV, or about 800 mV).

In still further embodiments, the pH of the water is between about 4 to about 8 (e.g., about 4, about 5, about 6, about 7, or about 8). In some embodiments of each or any of the above- or below-mentioned embodiments, the composition or solution is used in the method to deliver a nutrient solute to the interior of a cell (e.g., a plant cell).

In some embodiments of each or any of the above- or below-mentioned embodiments, the composition or solution is used for an agricultural application. In some embodiments, the composition or solution is used for fertilizer delivery, soil or plant hydration, fungal growth support, plant moisture retention, asexual propagation plant survival, or seed germination. In some embodiments, the composition or solution is used for herbicide delivery.

The present disclosure also provides a method of using a composition or solution that includes ultrafine bubbles that comprise or consist essentially of water molecules surrounding the gases released from solution in the water dissolving, surrounding, and/or stabilizing a solute (e.g., nutrient necessary for cannabis and/or hops growth and development), wherein the ultrafine bubbles have a median diameter of between about 2 to about 400 nanometers, and wherein the ultrafine bubbles have improved bioavailability relative to a composition or a solution that does not include ultrafine bubbles that comprise or consist essentially of water molecules surrounding the gases released from solution in the water. In some embodiments, the ultrafine bubbles have a median of about 150 to about 300 water molecules per ultrafine bubble. In other embodiments, the ultrafine bubbles have a median of about 25, about 30, about 35, about 40, about 45, about 50, about 75, about 100, about 125, about 150, about 175, about 200, about 225, about 250, about 275, about 300, about 325, about 350, about 375, about 400, about 425, about 450, about 475, or about 500 water molecules per ultrafine bubble.

The present disclosure also provides methods for improving the bioavailability of a solute (e.g., a nutrient necessary for cannabis growth, an herbicide). In certain embodiments, the methods comprise dissolving the solute in water and dissolving/surrounding/stabilizing the solute with ultrafine bubbles, wherein the ultrafine bubbles are between about 2 to about 400 nanometers in median diameter. In another embodiment, the ultrafine bubbles have a median size of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median size of between about 10 to about 20 nanometers or about 15 to about 20 nanometers, or about 20 to about 25 nanometers. In other embodiments, the ultrafine bubbles have a median size of between about 10 to about 50 nanometers, about 20 to about 50 nanometers, about 30 to about 50 nanometers, or about 40 to about 50 nanometers. In still other embodiments, the ultrafine bubbles have a median size of between about 50 to about 100 nanometers. In yet further embodiments, the ultrafine bubbles have a median size of between about 100 to about 200 nanometers, about 150 to about 200 nanometers, about 200 to about 300 nanometers, about 250 to about 300 nanometers, or about 300 to about 400 nanometers.

In some embodiments, the solute is a fertilizer and/or one or more nutrients important or necessary for cannabis and/or hops growth (e.g., nitrogen (N), phosphorus (P), potassium (K), calcium (Ca), magnesium (Mg), sulfur(S), iron (Fe), manganese (Mn), zinc (Zn), copper (Cu), boron (B), molybdenum (Mo), and chlorine (Cl)). It is believed that healthy growth of cannabis and/or hops facilitates the production of bioactive compounds in the flowers of such plants, including, but not limited to terpenes, THC, and other cannabinoids. Thus, in some embodiments, the compositions can be used to increase production of bioactive compounds in cannabis and/or hops plants (e.g., THC, other cannabinoids, terpenes).

In some embodiments, the solute is a fertilizer and/or one or more nutrients important or necessary for fungal/mushroom growth (e.g., carbon (C), nitrogen (N), phosphorus (P), potassium (K), calcium (Ca), magnesium (Mg), sulfur(S), iron (Fe), manganese (Mn), zinc (Zn), copper (Cu), boron (B), molybdenum (Mo), and chlorine (Cl)). It is believed that healthy growth of fungi/mushrooms facilitates the production of bioactive and/or psychoactive compounds therein, including, but not limited to psilocybin, psilocin, baeocystin, and norbaeocystin. Thus, in some embodiments, the compositions can be used to increase production of bioactive and/or psychoactive compounds in fungi/mushrooms.

In some embodiments, the solute is an agent or compound capable of inducing plants to retain moisture such that portions harvested from the plants retain moisture and/or exhibit reduced wilting.

In some embodiments, the solute is a nutrient or compound capable of reducing die-off, improving survivability, and/or improving overall health of artificially asexually propagated cultivars (e.g., clone cuttings).

In other embodiments, the solute is an herbicidal agent or compound (e.g., diquat dibromide; fluazifop-p-butyl; dicamba, dimethylamine salt; 2,4-D, dimethylamine salt; mecoprop-p, dimethylamine salt; glyphosate; and/or sulfentrazone).

The present disclosure also provides methods for dissolving, surrounding, and/or stabilizing a solute in water comprising mixing the solute with water and dissolving/surrounding/stabilizing the solute with ultrafine bubbles having a median diameter of between about 2 to about 400 nanometers. In another embodiment, the ultrafine bubbles have a median size of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median size of between about 10 to about 20 nanometers or about 15 to about 20 nanometers, or about 20 to about 25 nanometers. In other embodiments, the ultrafine bubbles have a median size of between about 10 to about 50 nanometers, about 20 to about 50 nanometers, about 30 to about 50 nanometers, or about 40 to about 50 nanometers. In still other embodiments, the ultrafine bubbles have a median size of between about 50 to about 100 nanometers. In yet further embodiments, the ultrafine bubbles have a median size of between about 100 to about 200 nanometers, about 150 to about 200 nanometers, about 200 to about 300 nanometers, about 250 to about 300 nanometers, or about 300 to about 400 nanometers.

### BRIEF DESCRIPTION OF THE FIGURES

FIG. 1 shows a diagram of a system (101) and a method for making compositions including water and ultrafine bubbles in accordance with embodiments of the disclosure.

FIG. 2 shows a graph of yield increase for both THC and overall terpenes in three cannabis strains treated with compositions in accordance with embodiments of the disclosure.

FIG. 3 displays a graph and photographs of root growth in two sets of propagated cannabis clonal cuttings treated with compositions in accordance with embodiments of the disclosure.

FIG. 4 displays a graph and photographs of root plug classes in two sets of propagated cannabis clonal cuttings treated with compositions in accordance with embodiments of the disclosure.

FIG. 5 depicts photographs of herbicidal effectiveness in accordance with embodiments of the disclosure.

FIG. 6 depicts photographs of herbicidal effectiveness in accordance with embodiments of the disclosure.

FIG. 7 depicts the impact of different sorbic acid concentrations on yeast growth in the deionized water flasks in accordance with embodiments of the disclosure.

FIG. 8 depicts the impact of different sorbic acid concentrations on yeast growth in the flasks containing the water prepared in accordance with embodiments of the disclosure.

FIG. 9 depicts a comparison of yeast growth under the influence of 50 mg/L sorbic acid in YPD media mixtures made with DI water versus water prepared in accordance with embodiments of the disclosure.

FIG. 10 depicts a comparison of yeast growth under the influence of 100 mg/L sorbic acid in YPD media mixtures made with DI water versus water prepared in accordance with embodiments of the disclosure.

FIG. 11 depicts photographs documenting the wilting progression of lettuce leaves, comparing the relative difference between those treated with deionized (DI) water (control) and those treated with the ultrafine bubble suspension (test) in accordance with embodiments of the present disclosure.

FIG. 12 depicts a box plot illustrating the statistically significant increase in biomass yield when water prepared in accordance with embodiments of the present disclosure used in the fermentation medium, compared to the control medium with DI water.

### DETAILED DESCRIPTION

The present disclosure provides compositions and methods for using the compositions and solutions (e.g., aqueous compositions) that include ultrafine bubbles comprising or consisting essentially of water and gases released from solution in the water, and, optionally, a non-gaseous solute. It has surprisingly been found that compositions according to the disclosure herein can be applied to cannabis and/or hops plants throughout their growth to increase yield of the flower buds containing bioactive compounds (e.g., THC, other cannabinoids, terpenes) and the content/potency of the bioactives. Indeed, the inventors have surprisingly discovered that aqueous compositions that comprise a low concentration of ultrafine bubbles (e.g., at a concentration of up to 10⁸ ultrafine bubbles/mL) exert improved/increased bioavailability, solubility, permeability with respect to biological membranes, and/or stability than previously anticipated, perhaps even as compared to compositions that comprise a higher concentration of ultrafine bubbles (e.g., more than 10⁸ ultrafine bubbles/mL). The compositions include water with stable ultrafine bubbles comprising about 100 to about 500 water molecules. The compositions include one or more solutes comprising one or more nutrients necessary for healthy cannabis and/or hops plant growth, such that the methods result in higher bioactive yield and/or potency in the resulting cannabis and/or hops plants when compared to the bioactive yield and/or potency of cannabis and/or hops plants which have not been treated with such compositions and solutions. Methods for using these compositions are also included.

It has also surprisingly been found that compositions according to the disclosure herein can be applied to fungi/mushrooms throughout their growth to increase yield of bioactive and/or psychoactive compounds (e.g., psilocybin, psilocin, baeocystin, and norbaeocystin) and the content/potency of the bioactives/psychoactives. In particular, it has been surprisingly found that aqueous compositions in accordance with the disclosure herein may comprise a low concentration of ultrafine bubbles (e.g., at a concentration of up to 10⁸ ultrafine bubbles/mL) yet exert improved/increased bioavailability, solubility, permeability with respect to biological membranes, and/or stability as compared to compositions that comprise a higher concentration of ultrafine bubbles (e.g., more than 10⁸ ultrafine bubbles/mL). The compositions include water with stable ultrafine bubbles comprising about 100 to about 500 water molecules. The compositions include one or more solutes comprising one or more nutrients necessary for healthy fungal and/or mushroom growth, such that the methods result in higher bioactive yield and/or potency in the resulting fungi/mushrooms when compared to the bioactive yields/potency of fungi/mushrooms which have not been treated with such compositions and solutions. Methods for using these compositions are also included.

It has been surprisingly found that compositions according to the disclosure herein can be applied to artificially asexually reproduced plants (e.g., clonal cuttings) to induce regeneration and/or rooting, reduce die-off, improve overall health, and/or improve survival. In particular, it has been surprisingly found that aqueous compositions in accordance with the disclosure herein may comprise a low concentration of ultrafine bubbles (e.g., at a concentration of up to 10⁸ ultrafine bubbles/mL) yet exert improved/increased bioavailability, solubility, permeability with respect to biological membranes, and/or stability as compared to compositions that comprise a higher concentration of ultrafine bubbles (e.g., more than 10⁸ ultrafine bubbles/mL). The compositions include water with stable ultrafine bubbles comprising about 100 to about 500 water molecules. The compositions include one or more solutes comprising one or more nutrients helpful or necessary for plant propagation, such that the methods result in improved survival and overall health in the asexually propagated plants treated with such compositions when compared to plants which have not been treated with such compositions and solutions. Methods for using these compositions are also included.

It has also surprisingly been found that compositions according to the disclosure herein can be applied to plants to enable moisture retention such that plant materials harvested therefrom retain moisture, have reduced moisture loss, and/or exhibit reduced wilting. In particular, it has been surprisingly found that aqueous compositions in accordance with the disclosure herein may comprise a low concentration of ultrafine bubbles (e.g., at a concentration of up to 10⁸ ultrafine bubbles/mL) yet exert improved/increased bioavailability, solubility, permeability with respect to biological membranes, and/or stability as compared to compositions that comprise a higher concentration of ultrafine bubbles (e.g., more than 10⁸ ultrafine bubbles/mL). The compositions include water with stable ultrafine bubbles comprising about 100 to about 500 water molecules. The compositions include one or more solutes comprising one or more compounds or agents helpful or necessary for plant water/moisture retention, such that the methods result in improved water/moisture retention and/or reduced wilting in plant materials harvested from plants treated with such compositions when compared to plant materials harvested from plants which have not been treated with such compositions and solutions. Methods for using these compositions are also included.

It has also been surprisingly found that compositions according to the disclosure herein can be used to increase herbicidal efficacy such that embodiments of the compositions including herbicidal agents and/or compounds will result in more efficient destruction of unwanted plants or vegetation in comparison to herbicidal compositions not prepared in accordance with the disclosure. In particular, it has been surprisingly found that aqueous compositions in accordance with the disclosure herein may comprise a low concentration of ultrafine bubbles (e.g., at a concentration of up to 10⁸ ultrafine bubbles/mL) yet exert improved/increased bioavailability, solubility, permeability with respect to biological membranes, and/or stability as compared to compositions that comprise a higher concentration of ultrafine bubbles (e.g., more than 10⁸ ultrafine bubbles/mL). The compositions include water with stable ultrafine bubbles comprising about 100 to about 500 water molecules. Methods for using these compositions are also included.

The ultrafine bubbles may comprise or consist essentially of water and gases released from solution in the water. The ultrafine bubbles may be used advantageously to dissolve, surround, and/or stabilize a non-gaseous solute (e.g., a plant nutrient, a fungal nutrient, an organic chemical, an inorganic chemical, a fertilizer, or an herbicide) and used to deliver the solute across a cell membrane of a plant (e.g., a cannabis plant, an unwanted weed or invasive plant) or fungus to exert its effect. As such, the disclosed compositions and solutions provide surprising and unexpected advantages in promoting healthy growth of plants (e.g., cannabis and/or hops), fungus, increasing bioactive (e.g., THC, terpenes, psilocybin) yield thereof, and promoting herbicidal efficacy, based, for example, on the improved bioavailability, solubility, and/or stability of ultrafine bubbles comprising or consisting essentially of water and gases released from solution in the water, and potentially non-gaseous solutes included within the composition including the ultrafine bubbles.

Also provided by the present disclosure are methods for making aqueous ultrafine bubbles (e.g., from ultrapure water), including methods for dissolving a solute (e.g., a plant nutrient) in an aqueous composition including ultrafine bubbles comprising or consisting essentially of water and gases released from solution in the water. The ultrafine bubbles comprising or consisting essentially of water and gases released from solution in the water may be used to dissolve, stabilize, and/or surround solutes (e.g., plant nutrients, inorganic chemicals, or organic chemicals). In certain embodiments of the methods, the ultrafine bubbles in the composition have a median size of between about 2 to about 400 nanometers. In another embodiment, the ultrafine bubbles have a median size of between about 2 to about 10 nanometers (e.g., about 2 nanometers, about 3 nanometers, about 4 nanometers, about 5 nanometers, about 6 nanometers, about 7 nanometers, about 8 nanometers, about 9 nanometers, or about 10 nanometers). In other embodiments, the ultrafine bubbles have a median size of between about 10 to about 20 nanometers or about 15 to about 20 nanometers, or about 20 to about 25 nanometers. In other embodiments, the ultrafine bubbles have a median size of between about 10 to about 50 nanometers, about 20 to about 50 nanometers, about 30 to about 50 nanometers, or about 40 to about 50 nanometers. In still other embodiments, the ultrafine bubbles have a median size of between about 50 to about 100 nanometers. In yet further embodiments, the ultrafine bubbles have a median size of between about 100 to about 200 nanometers, about 150 to about 200 nanometers, about 200 to about 300 nanometers, about 250 to about 300 nanometers, or about 300 to about 400 nanometers.

The present disclosure also provides compositions and solutions used in the methods wherein 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of the composition or solution includes ultrafine bubbles comprising or consisting essentially of water and gases released from solution in the water and a solute, wherein the ultrafine bubbles dissolve, surround, and/or stabilize the solute.

In some embodiments of the methods, about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of the ultrafine bubbles comprising or consisting essentially of water and gases released from solution in the water in the composition or solution dissolve, surround, and/or stabilize the solute.

In some embodiments of the methods, one or more of the solutes is present at a concentration of from about 1 mg/L to about 1000 mg/L of composition according to the disclosure herein. Compositions and solutions used in the methods herein include the one or more solutes at a concentration of about 1 mg/L, about 2 mg/L, about 3 mg/L, about 4 mg/L, about 5 mg/L, about 10 mg/L, about 20 mg/L, about 30 mg/L, about 40 mg/L, about 50 mg/L, about 60 mg/L, about 70 mg/L, about 80 mg/L, about 90 mg/L, about 100 mg/L, about 110 mg/L, about 120 mg/L, about 130 mg/L, about 140 mg/L, about 150 mg/L, about 160 mg/L, about 170 mg/L, about 180 mg/L, about 190 mg/L, about 200 mg/L, about 210 mg/L, about 220 mg/L, about 230 mg/L, about 240 mg/L, about 250 mg/L, about 260 mg/L, about 270 mg/L, about 280 mg/L, about 290 mg/L, about 300 mg/L, about 310 mg/L, about 320 mg/L, about 330 mg/L, about 340 mg/L, about 350 mg/L, about 360 mg/L, about 370 mg/L, about 380 mg/L, about 390 mg/L, about 400 mg/L, about 410 mg/L, about 420 mg/L, about 430 mg/L, about 440 mg/L, about 450 mg/L, about 460 mg/L, about 470 mg/L, about 480 mg/L, about 490 mg/L, about 500 mg/L, about 510 mg/L, about 520 mg/L, about 530 mg/L, about 540 mg/L, about 550 mg/L, about 560 mg/L, about 570 mg/L, about 580 mg/L, about 590 mg/L, about 600 mg/L, about 610 mg/L, about 620 mg/L, about 630 mg/L, about 640 mg/L, about 650 mg/L, about 660 mg/L, about 670 mg/L, about 680 mg/L, about 690 mg/L, about 700 mg/L, about 710 mg/L, about 720 mg/L, about 730 mg/L, about 740 mg/L, about 750 mg/L, about 760 mg/L, about 770 mg/L, about 780 mg/L, about 790 mg/L, about 800 mg/L, about 810 mg/L, about 820 mg/L, about 830 mg/L, about 840 mg/L, about 850 mg/L, about 860 mg/L, about 870 mg/L, about 880 mg/L, about 890 mg/L, about 900 mg/L, about 910 mg/L, about 920 mg/L, about 930 mg/L, about 940 mg/L, about 950 mg/L, about 960 mg/L, about 970 mg/L, about 980 mg/L, about 990 mg/L, or about 1000 mg/L.

In some embodiments, the bioactive yield of one or more bioactive compounds (e.g. THC, terpenes, other cannabinoids) is increased by at least 2 wt % in cannabis blooms yielded by growing female cannabis plants to which the composition is applied as compared to cannabis blooms yielded by growing female cannabis plants of the same strain to which the composition is not applied. In some embodiments, the THC yield is increased by at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt %, or at least 25 wt %. In some embodiments, the yield of one or more other cannabinoids is increased by at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt %, or at least 25 wt %. In some embodiments, the yield of one or more terpenes is increased by at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt %, or at least 25 wt %.

Terpenes which may increase in yield and/or potency include, but are not limited to: 7,8-dihydro-alpha-ionone, 7,8-dihydro-beta-ionone, Acetanisole, Acetic Acid, Acetyl Cedrene, Anethole, Anisole, Benzaldehyde, Bergamotene (Alpha-cis-Bergamotene) (Alpha-trans-Bergamotene), Bisabolol (Beta-Bisabolol), Alpha, Bisabolol, Borneol, Bornyl Acetate, Butanoic/Butyric Acid, Cadinene (Alpha-Cadinene) (Gamma-Cadinene), Cafestol, Caffeic acid, Camphene, Camphor, Capsaicin, Carene (Delta-3-Carene), Carotene, Carvacrol, Dextro-Carvone, Laevo-Carvone, Caryophyllene (Beta-Caryophyllene), Caryophyllene oxide, Cedrene (Alpha-Cedrene) (Beta-Cedrene), Cedrene Epoxide (Alpha-Cedrene Epoxide), Cedrol, Cembrene, Chlorogenic Acid, Cinnamaldehyde, Alpha-amyl-Cinnamaldehyde, Alpha-hexyl-Cinnamaldehyde, Cinnamic Acid, Cinnamyl Alcohol, Citronellal, Citronellol, Cryptone, Curcumene (Alpha-Curcumene) (Gamma-Curcumene), Decanal, Dehydrovomifoliol, Diallyl Disulfide, Dihydroactinidiolide, Dimethyl Disulfide, Eicosane/lcosane, Elemene (Beta-Elemene), Estragole, Ethyl acetate, Ethyl Cinnamate, Ethyl maltol, Eucalyptol/1,8-Cineole, Eudesmol (Alpha-Eudesmol) (Beta-Eudesmol) (Gamma-Eudesmol), Eugenol, Euphol, Farnesene, Farnesol, Fenchol (Beta-Fenchol), Fenchone, Geraniol, Geranyl acetate, Germacrenes, Germacrene B, Guaia-1(10),11-diene, Guaiacol, Guaiene (Alpha-Guaiene), Gurjunene (Alpha-Gurjunene), Herniarin, Hexanaldehyde, Hexanoic Acid, Humulene (Alpha-Humulene) (Beta-Humulene), Ionol (3-oxo-alpha-ionol) (Beta-Ionol), Ionone (Alpha-Ionone) (Beta-Ionone), Ipsdienol, Isoamyl Acetate, Isoamyl Alcohol, Isoamyl Formate, Isoborneol, Isomyrcenol, Isopulegol, Isovaleric Acid, Isoprene, Kahweol, Lavandulol, Limonene, Gamma-Linolenic Acid, Linalool, Longifolene, Alpha-Longipinene, Lycopene, Menthol, Methyl butyrate, 3-Mercapto-2-Methylpentanal, Mercaptan/Thiols, Beta-Mercaptoethanol, Mercaptoacetic Acid, Allyl Mercaptan, Benzyl Mercaptan, Butyl Mercaptan, Ethyl Mercaptan, Methyl Mercaptan, Furfuryl Mercaptan, Ethylene Mercaptan, Propyl Mercaptan, Thenyl Mercaptan, Methyl Salicylate, Methylbutenol, Methyl-2-Methylvalerate, Methyl Thiobutyrate, Myrcene (Beta-Myrcene), Gamma-Muurolene, Nepetalactone, Nerol, Nerolidol, Neryl acetate, Nonanaldehyde, Nonanoic Acid, Ocimene, Octanal, Octanoic Acid, P-Cymene, Pentyl butyrate, Phellandrene, Phenylacetaldehyde, Phenylethanethiol, Phenylacetic Acid, Phytol, Pinene, Beta-Pinene, Propanethiol, Pristimerin, Pulegone, Quercetin, Retinol, Rutin, Sabinene, Sabinene Hydrate, cis-Sabinene Hydrate, trans-Sabinene Hydrate, Safranal, Alpha-Selinene, Alpha-Sinensal, Beta-Sinensal, Beta-Sitosterol, Squalene, Taxadiene, Terpin hydrate, Terpineol, Terpine-4-ol, Alpha-Terpinene, Gamma-Terpinene, Terpinolene, Thiophenol, Thujone, Thymol, Alpha-Tocopherol, Tonka Undecanone, Undecanal, Valeraldehyde/Pentanal, Verdoxan, Alpha-Ylangene, Umbelliferone, or Vanillin. Cannabinoids, including THC, which may increase in yield and/or potency include, but are not limited to: Cannabigerolic Acid (CBGA), Cannabigerolic Acid monomethylether (CBGAM), Cannabigerol (CBG), Cannabigerol monomethylether (CBGM), Cannabigerovarinic Acid (CBGVA), Cannabigerovarin (CBGV), Cannabichromenic Acid (CBCA), Cannabichromene (CBC), Cannabichromevarinic Acid (CBCVA), Cannabichromevarin (CBCV), Cannabidiolic Acid (CBDA), Cannabidiol (CBD), Cannabidiol monomethylether (CBDM), Cannabidiol-C4 (CBD-C4), Cannabidivarinic Acid (CBDVA), Cannabidivarin (CBDV), Cannabidiorcol (CBD-C1), Tetrahydrocannabinolic acid A (THCA-A), Tetrahydrocannabinolic acid B (THCA-B), Tetrahydrocannabinolic Acid (THCA), Tetrahydrocannabinol (THC), Tetrahydrocannabinolic acid C4 (THCA-C4), Tetrahydrocannabinol C4 (THC-C4), Tetrahydrocannabivarinic acid (THCVA), Tetrahydrocannabivarin (THCV), Tetrahydrocannabiorcolic acid (THCA-C1), Tetrahydrocannabiorcol (THC-C1), Δ7-cis-iso-tetrahydrocannabivarin, Δ8-tetrahydrocannabinolic acid (Δ8-THCA), Cannabivarinodiolic (CBNDVA), Cannabivarinodiol (CBNDV), Δ8-tetrahydrocannabinol (Δ8-THC), Δ9-tetrahydrocannabinol (Δ9-THC), Cannabicyclolic acid (CBLA), Cannabicyclol (CBL), Cannabicyclovarin (CBLV), Cannabielsoic acid A (CBEA-A), Cannabielsoic acid B (CBEA-B), Cannabielsoin (CBE), Cannabivarinselsoin (CBEV), Cannabivarinselsoinic Acid (CBEVA), Cannabielsoic Acid (CBEA), Cannabielvarinsoin (CBLV), Cannabielvarinsoinic Acid (CBLVA), Cannabinolic acid (CBNA), Cannabinol (CBN), Cannabivarinic Acid (CBNVA), Cannabinol methylether (CBNM), Cannabinol-C4 (CBN-C4), Cannabivarin (CBV), Cannabino-C2 (CBN-C2), Cannabiorcol (CBN-C1), Cannabinodiol (CBND), Cannabinodiolic Acid (CBNDA), Cannabinodivarin (CBDV), Cannabitriol (CBT), 10-Ethoxy-9-hydroxy-Δ6a-tetrahydrocannabinol, 8,9-Dihydroxy-Δ6a(10a)-tetrahydrocannabinol (8,9-Di-OH-CBT-C5), Cannabitriolvarin (CBTV), Ethoxy-cannabitriolvarin (CBTVE), Dehydrocannabifuran (DCBF), Cannbifuran (CBF), Cannabichromanon (CBCN), Cannabicitran (CBT), 10-Oxo-Δ6a(10a)-tetrahydrocannabinol (OTHC), Δ9-cis-tetrahydrocannabinol (cis-THC), Cannabiripsol (CBR), 3,4,5,6-tetrahydro-7-hydroxy-alpha-alpha-2-trimethyl-9-n-propyl-2,6-methano-2H-1-benzoxocin-5-methanol (OH-iso-HHCV), Trihydroxy-delta-9-tetrahydrocannabinol (triOH-THC), Yangonin, Epigallocatechin gallate, Dodeca-2E, 4E, 8Z, 10Z-tetraenoic acid isobutylamide, and Dodeca-2E,4E-dienoic acid isobutylamide.

In some embodiments, the bioactive yield (e.g., terpenes, other cannabinoids) is increased by at least 2 wt % in hops blooms yielded by growing female hops plants to which the composition is applied as compared to hops blooms yielded by growing female hops plants of the same strain to which the composition is not applied. In some embodiments, the bioactive (e.g., terpene) yield is increased by at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt %, or at least 25 wt %.

In some embodiments, the bioactive yield (e.g., psilocybin, psilocin, baeocystin, norbaeocystin, other bioactives/psychoactives) is increased by at least 2 wt % by growing the fungi/mushrooms to which the composition is applied as compared to the bioactives/psychoactives yielded by the same species to which the composition is not applied. In some embodiments, the bioactive (e.g., psilocybin, psilocin, baeocystin, norbaeocystin) yield is increased by at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 13 wt %, at least 14 wt %, at least 15 wt %, at least 16 wt %, at least 17 wt %, at least 18 wt %, at least 19 wt %, at least 20 wt %, at least 21 wt %, at least 22 wt %, at least 23 wt %, at least 24 wt %, or at least 25 wt %.

In some embodiments of the methods disclosed herein, the composition is applied to the growing female cannabis or hops plant during a flowering/fruiting/blooming stage. In other embodiments, the composition is applied to the growing female cannabis or hops plant during a vegetative phase. In another embodiment, the composition is applied to the growing female cannabis or hops plants during a seed germination phase. In yet still other embodiments, the composition is applied to the growing female cannabis or hops plant during a clone propagation phase. In particular embodiments thereof, the growing female cannabis or hops plants are grown via hydroponic technique during at least part of the clone propagation phase. In particular embodiments, the composition is applied to the growing female cannabis or hops plant during the clone propagation phase in which the growing female cannabis or hops plant is being grown via hydroponic technique. In some embodiments, the survival of artificially asexually propagated plants is increased by about 5-15% in cultivars treated with compositions according to the present disclosure as compared to the same types of cultivars not treated with compositions according to the disclosure. In some embodiments, the survival rate is increased by at least 5%, at least 6%, at least 7%, at least 8%, at least 9%, at least 10%, at least 11%, at least 12%, at least 13%, at least 14%, or at least 15%.

In some embodiments, the herbicidal efficacy of herbicidal agents and/or compounds as part of compositions according to the disclosure herein is increased by at least 30% in comparison to the herbicidal efficacy of compositions having the same amount of herbicidal agents and/or compounds but not prepared in accordance with the disclosure. In some embodiments, the efficacy is increased at least 30%, at least 35%, at least 40%, at least 45%, at least 50%, at least 55%, at least 60%, at least 65%, at least 70%, at least 75%, at least 80%, at least 85%, at least 90%, at least 95%, at least 100%, at least 105%, at least 110%, at least 115%, at least 120%, at least 125%, at least 130%, at least 135%, at least 140%, at least 145%, at least 150%, at least 155%, at least 160%, at least 165%, at least 170%, at least 175%, at least 180%, at least 185%, at least 190%, at least 195%, or at least 200%.

Without being bound by theory, it is believed the compositions as disclosed herein provide for improved bioavailability, solubility, and/or stability of the ultrafine bubbles comprising or consisting essentially of water and gases released from solution in water, as well as improved bioavailability, solubility, and/or stability of any dissolved solutes because the ultrafine bubbles are produced from “soft” or gaseous cavitation rather than “hard” or vaporous cavitation processes. The disclosed ultrafine bubbles are believed to be (a) nucleated in the low-pressure vicinity surrounding the cavitation core, (b) sheared-off bubbles from the cavitation core itself, or (c) produced via low pressure/room temperature boiling at the core surface, such that, in the presence of turbulence and high shear stresses near the core, ultrafine bubbles are broken into smaller ultrafine bubbles through deformation (due to drag forces). The resulting compositions incorporating such ultrafine bubbles exhibit improved efficacy for dissolving solutes, even at concentrations of 10⁸ ultrafine bubbles/mL and below. Such compositions also exhibit enhanced stability over other solutions incorporating ultrafine bubbles or ultrafine bubbles produced via other means, as they can be concentrated by several orders of magnitude via rotary evaporation or crossflow filtration without ultrafine bubble loss or solute dissolution, and can even remain bottled for up to 10 years without loss of ultrafine bubble concentration or dissolution of solutes.

Unless otherwise indicated, all numbers expressing quantities of ingredients, properties such as molecular weight and median size, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure.

While the present disclosure has been described and illustrated herein by references to various specific materials, procedures and examples, it is understood that the disclosure is not restricted to the particular combinations of materials and procedures selected for that purpose. Numerous variations of such details can be implied as will be appreciated by those skilled in the art. It is intended that the specification and examples be considered as exemplary only, with the true scope and spirit of the disclosure being indicated by the following claims. All references, patents, and patent applications referred to in this application are herein incorporated by reference in their entirety.

Further definitions of terms will be given in the following in the context of which the terms are used. The following terms or definitions are provided solely to aid in the understanding of the invention. These definitions should not be construed to have a scope less than understood by a person of ordinary skill in the art.

As used herein, an “ultrafine bubble” refers to an assembly of water molecules, with a diameter less than one micron, bonded with or otherwise associated with one another by electrostatic forces, such as hydrogen bonding, ionic bonding, van der Waals forces, or the like, surrounding gases (e.g., gases released from solution in water). In some cases according to the disclosure, an ultrafine bubble further comprises a non-gaseous solute associated with the water molecules and dissolved within, surrounded by, and/or stabilized by the ultrafine bubble.

As used herein, a “solute” means a substance or particle that is fully or partially dissolved in water. In embodiments, a solute of the disclosure is dissolved within, surrounded by, and/or stabilized by ultrafine bubbles of the disclosure. A solute according to the disclosure comprises, without limitation, a plant nutrient, an ion, a polar or non-polar substance, a liquid, a solid, a lipid, a protein, a peptide, a nucleic acid, an organic compound, an inorganic compound, or any combination thereof.

As used herein, “ultrapure water” means water prepared according to one or more of the described embodiments of the disclosure. In particular, ultrapure water refers to water prepared by methods and processes disclosed herein, or water characterized as being completely free of (e.g., does not contain any detectable amount), or substantially free of (e.g., 70%, 80%, 90%, or 95% free of), one or more impurities or contaminants.

As used herein, “bioavailability” refers to the physiological availability of a given amount of a solute as distinct from its chemical potency. For example, bioavailability refers to the proportion of an administered solute that is absorbed into the tissues of a plant (e.g., a cannabis plant) or fungus. Bioavailability also refers to the ability of an ultrafine bubble, solute, particle, dissolved solute, or combination thereof, to access a biological target, e.g., by crossing a biological membrane or by interacting with a biological receptor or other binding partner.

The disclosure provides methods using compositions and solutions comprising ultrafine bubbles comprising or consisting essentially of water and gases released from solution in the water, and a non-gaseous solute dissolved within, surrounded by, and/or stabilized by the ultrafine bubbles. The ultrafine bubble may have a median ultrafine bubble size of between about 2 to about 400 nanometers or a median of about 10 to about 500 water molecules per ultrafine bubble.

In some embodiments of the methods herein, ultrapure water of the disclosure comprises water substantially free of or completely free of contaminants (e.g., an impurity). As used herein, a contaminant is a foreign substance not intentionally added to the ultrapure water produced according to the disclosure. Thus, ultrapure water substantially free of contaminants contains undetectable levels/amounts of, for example, the following contaminants: (a) pathogenic bacteria (e.g., fecal coliform), viruses (e.g., hepatitis viruses, hemorrhagic viruses, retroviruses such as AIDS virus), fungi, mycoplasm, protozoa, prokaryotes, protists, parasites, microorganisms causing infectious diseases, and their spores, eggs, DNA, RNA, or related reproductive constituents, prions, (b) toxic biochemicals including toxic proteins, lipids, carbohydrates, and toxic nucleic acids; (c) toxic inorganic chemicals (soluble and insoluble in water and including toxic heavy metals) and their particles; (d) toxic organic chemicals (soluble and insoluble in water and including pesticides) and their particles; (e) non-water organic liquids (miscible and immiscible); (f) radioactive minerals, or (g) toxic gases including ammonia, arsenic pentafluoride, arsine, bis(trifluoromethyl) peroxide, boron tribromide, boron trichloride, boron trifluoride, bromine, bromine chloride, boromethane, carbon monoxide, chlorine, chlorine pentafluoride, chlorine trifluoride, chloropicrin, cyanogen, cyanogen chloride, diazomethane, diborane, dichloroacetylene, dichlorosilane, fluorine, formaldehyde, germane, hexylethyl tetraphosphate, hydrogen azide, hydrogen cyanide, hydrogen selenide, hydrogen sulfide, hydrogen telluride, nickel tetracarbonyl, nitrogen dioxide, osmium tetroxide, oxygen difluoride, perfluroisobuytlene, phosgene, phosphine, phosphorus pentafluoride, selenium hexafluoride, silicon hexafluoride, silicon tetrachloride, stilbene, disulfur decafluoride, sulfur tetrafluoride, tellurium hexafluoride, tetraethyl pyrophosphate, tetraethyl dithiopyrophosphate, trifluoroacetyl chloride, tungsten hexafluroide, and radon.

Ultrapure water of the disclosure may be prepared by processes known in the art and used as a starting material for generating the compositions and solutions comprising ultrafine bubbles as disclosed herein. The ultrapure water of the disclosure may be prepared by carbon filtration, by slow sand filtration, by reverse osmosis, by electro-deionization treatment, by ultraviolet light exposure, or by a combination comprising two or more of the processes described herein. For example, the ultrapure water of the disclosure may be prepared by a sequential process comprising each of carbon filtration, slow sand filtration, reverse osmosis, electro-deionization treatment, and ultraviolet light exposure. Alternatively, the ultrapure water may be prepared according to one or more of the processes described herein in combination with other methods of water purification known in the art but not expressly recited herein.

The ultrapure water may be prepared by a process comprising the steps of: filtering a volume of water with a carbon filter to produce an amount of water with a low chlorine content; removing ions in the carbon filtered water by a reverse osmosis process to produce a supply of a deionized water; electro-deionizing the supply of the deionized water from the reverse osmosis process to make an ultrapure water supply; testing the resistivity of the ultrapure water to determine if the resistivity of the ultrapure water is between about 17 meg-ohm cm to about 18.2 meg-ohm cm; repeating a process step for preparing the ultrapure water and retesting the resistivity of the ultrapure water until the ultrapure water has a measured resistivity of between about 17 meg-ohm cm to about 18.2 meg-ohm cm; irradiating the supply of the ultrapure water having a measured resistivity of between about 17 meg-ohm cm to about 18.2 meg-ohm cm with ultraviolet light to make a sterilized ultrapure water supply; and storing the sterilized ultrapure water in a stainless steel container until sterilized ultrapure water is needed to be added in the process to make an aqueous composition comprising an aqueous medium with reduced size ultrafine bubbles containing a solute to improve bioavailability of the aqueous composition.

The ultrapure water is purified of contaminants including, for example, organic and inorganic compounds; dissolved and particulate matter; volatile and non-volatile matter, reactive and inert matter; and hydrophilic and hydrophobic matter. Ultrapure water and commonly used term deionized (DI) water are not the same. An ultrapure water system may include three stages: a pretreatment stage to produce purified water, a primary stage to further purify the water, and a polishing stage. The most widely used requirements for ultrapure water quality are documented by ASTM D5127 “Standard Guide for Ultra-Pure Water Used in the Electronics and Semiconductor Industries” and SEMI F63 “Guide for ultrapure water used in semiconductor processing.”

The polishing stage may include continuously treating and recirculating the purified water in order to maintain stable high purity quality of supplied water. Traditionally the resistivity of water serves as an indication of the level of purity of ultrapure water. Deionized (DI) water may have a purity of at least one million ohms-centimeter or one meg-ohm cm. In a preferred embodiment, the ultrapure water quality is at the theoretical maximum of water resistivity (18.18 meg-ohm cm at 25° C.).

The ultrapure water of the disclosure may have a high oxidative reduction potential including, for example, about 140 to about 160 mV. Further, the pH of the ultrapure water may be between about 3 to about 7, preferably about 4 to about 6 and the resistivity of the ultrapure water may be between about 17 to about 18.2 meg-ohm cm.

In some embodiments of the methods disclosed herein, the compositions and solutions used in the methods include ultrafine bubbles comprising or consisting essentially of ultrapure water and gases released from solution in the ultrapure water, wherein the ultrafine bubbles dissolve, surround, and/or stabilize a solute, and wherein the ultrapure water has a high negative oxidative reduction potential. In further embodiments, the oxidative reduction potential of the ultrapure water is about 80 mV to about 100 mV, about 100 mV to about 120 mV, about 120 mV to about 140 mV, or about 140 mV to about 160 mV. In still further embodiments, the pH of the ultrapure water is between about 4 to about 5, about 5 to about 6, or about 6 to about 7.

A non-gaseous solute dissolved in a composition including ultrafine bubbles comprising or consisting essentially of water and gases released from solution in the water may have an approximately round geometry, a flat plate geometry, a cube geometry, a rod-like geometry, a hollow geometry, and/or a semi-hollow geometry. In some embodiments, a solute dissolved in a composition including ultrafine bubbles comprising or consisting essentially of water and gases released from solution in the water may comprise a primary solute, a mixture of a first solute and a second solute, or a plurality of solutes. The solutes may have one or more additional associated solutes, such as a surface coating, as a subsurface coating, or in a complex with other solutes. The solutes may comprise a liquid, a solid, or be a colloidal system with a colloid and a dispersing agent.

In some embodiments of the methods claimed herein, the non-gaseous solute comprises an organic chemical, an inorganic chemical, a plant nutrient, an ion, or an element. nitrogen, phosphorous, potassium, calcium, magnesium, ammonium, sulfur, copper, iron, manganese, molybdenum, zinc, boron, silicon, cobalt, vanadium, urea, or any combination thereof. In some embodiments of the methods claimed herein, the one or more solutes is one or more of indole-3-butyric acid (IBA), naphthaleneacetic acid (NAA), and combinations thereof. In certain embodiments, the one or more solutes is one or more of one or more beneficial microbes. In certain embodiments, a solute dissolved in a composition including ultrafine bubbles comprising or consisting essentially of water is an ion of an ionizable salt. In certain embodiments, the ion is an ammonium ion, boron ion, calcium ion, chloride ion, cobalt ion, copper ion, iron ion, magnesium ion, manganese ion, molybdenum ion, phosphorus ion, potassium ion, silicon ion, sulfate ion, vanadium ion, or zinc ion. In certain embodiments, a solute dissolved in a composition including ultrafine bubbles comprising or consisting essentially of water is an herbicidal agent or compound.

The ultrafine bubbles comprising or consisting essentially of water and gases released from solution in the water and have a median diameter of between about 2 to about 400 nanometers or comprise about 10 to about 500 molecules of water per ultrafine bubble. In certain embodiments, the ultrafine bubbles have a median diameter of about 1 nanometer, about 2 nanometers, about 3 nanometers, about 4 nanometers, about 5 nanometers, about 6 nanometers, about 7 nanometers, about 8 nanometers, about 9 nanometers, about 10 nanometers, about 11 nanometers, about 12 nanometers, about 13 nanometers, about 14 nanometers, about 15 nanometers, about 16 nanometers, about 17 nanometers, about 18 nanometers, about 19 nanometers, or about 20 nanometers. In other embodiments, the ultrafine bubbles according to the disclosure comprise a median diameter of about 20 nanometers, about 22 nanometers, about 24 nanometers, about 26 nanometers, about 28 nanometers, or about 30 nanometers. In still other embodiments, the ultrafine bubbles according to the disclosure comprise a median diameter of about 35 nanometers, about 40 nanometers, about 45 nanometers, about 50 nanometers, about 60 nanometers, about 70 nanometers, about 80 nanometers, about 90 nanometers, or about 100 nanometers.

In some embodiments, the ultrafine bubble comprises about 20, about 25, about 30, about 35, about 40, about 45, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 360, about 370, about 380, about 390, about 400, about 410, about 420, about 430, about 440, about 450, about 460, about 470, about 480, about 490, or about 500 water molecules. In other embodiments, the ultrafine bubble comprises between about 50 and about 100 water molecules, about 100 to about 150 water molecules, about 150 to about 200 water molecules, about 200 to about 250 water molecules, about 250 to about 300 water molecules, about 300 to about 350 water molecules, about 350 to about 400 water molecules, about 400 to about 450 water molecules, or about 450 to about 500 water molecules.

In some embodiments, the ultrafine bubbles fully dissolve, surround, and/or stabilize a non-gaseous solute or substantially dissolve, surround, and/or stabilize a non-gaseous solute (e.g., dissolves, surrounds, and/or stabilizes about 50%, 55%, 60%, 65%, 70%, 80%, 85%, 90%, 95% or more of an individual ion or molecule of the non-gaseous solute).

Those skilled in the art will recognize different ways of measuring a diameter of an ultrafine bubble of the disclosure. In an exemplary method a diameter of an ultrafine bubble is measured using a Malvern Instruments Zetasizer Nano ZSP, which is a high performance system and particularly suitable for the characterization of ultrafine bubbles, solutes, e.g. proteins and other nanoparticles. Optionally, the particle size measurements for the Zetasizer Nano are automated using a NanoSampler. In another exemplary method a diameter of an ultrafine bubble is measured using liquid-cell transmission electron microscopy (TEM). Additionally, the size distribution and concentration of an ultrafine bubble suspension may be measured on a particle-by-particle basis using tunable resistive pulse sensing (TRPS) or electrical zone sensing, using such instruments as the Izon Exoid or the Beckman Coulter Multisizer 4e, respectively.

In some embodiments, the ultrafine bubble and solutes of the disclosure are measured according to the following non-limiting parameters: ultrafine bubble diameter, particle and molecule size, translational diffusion, electrophoretic mobility, zeta potential of particles at high and low concentrations, viscosity and viscoelasticity of protein and polymer solutions, concentration, and/or molecular weight (e.g. k_{D}).

In some embodiments, the ultrafine bubbles comprising or consisting essentially of water and gases released from solution in the water used in such methods are stable for an extended storage period including, for example, a period of years. In some embodiments, the ultrafine bubbles are stable for about 2 years, about 4 years, about 6 years, about 8 years, or about 10 years. In some embodiments, the ultrafine bubbles are stable for a period in excess of 10 years.

In some embodiments, the ultrafine bubbles used in embodiments of the methods stabilize, surround, and/or dissolve a non-gaseous solute for a period of years, for example for about 2 years, about 4 years, about 6 years, about 8 years, or about 10 years. In further embodiments, the ultrafine bubbles dissolve, surround, and/or stabilize a non-gaseous solute for a period in excess of 10 years.

In some embodiments, the compositions or solutions include ultrafine bubbles comprising or consisting essentially of water and gases released from solution in the water, wherein the water has a high negative oxidative reduction potential including, for example, an oxidative reduction potential of about 140 to about 160 mV. In still further embodiments, the pH of the water is between about 4 to about 6. In some embodiments, the water is ultrapure water.

In some embodiments, the disclosure provides compositions or solutions for use in delivering a non-gaseous solute to the interior of a cell. In other embodiments, the disclosure provides compositions or solutions for use in delivering a non-gaseous solute to the interior of a plant cell.

Embodiments of the methods set forth in the disclosure include compositions or solutions wherein a non-gaseous solute is dissolved within, surrounded by, and/or stabilized by ultrafine bubbles comprising or consisting essentially of water and gases released from solution in the water, and has improved bioavailability relative to a composition or a solution where the solute is not dissolved, stabilized, and/or surrounded by ultrafine bubbles comprising or consisting essentially of water and gases released from solution in the water. In some embodiments, the solute dissolved within, surrounded by, and/or stabilized by ultrafine bubbles has improved bioavailability by virtue of its ability to access the interior of a cell. In some embodiments, the solute dissolved within, surrounded by, and/or stabilized by an ultrafine bubble has improved bioavailability by virtue of its ability to access the interior of a plant cell. For example, a water may have an impurity or a solute that is typically incapable of passing through a cell membrane, but the solute dissolved within, surrounded by, and/or stabilized by the ultrafine bubbles of the disclosure are able to cross a cell membrane. In some embodiments, a cell membrane may be a plasma membrane, a nuclear membrane, a cell wall, or any other impermeable barrier defining the boundaries of a cell or an organelle within a cell.

In other embodiments of the methods set forth herein, a solute dissolved within, surrounded by, or stabilized by ultrafine bubbles comprising or consisting essentially of water and gases released from solution in the water has improved bioavailability by virtue of its ability to access an intracellular space. In still other embodiments, the solute dissolved within, surrounded by, and/or stabilized by ultrafine bubbles has improved bioavailability by virtue of its ability to access specific plant or animal tissue types, such as root or leaf tissue in a plant. In yet other embodiments, an ultrafine bubble comprising or consisting essentially of ultrapure water and gases released from solution in the water has improved bioavailability relative to an ultrafine bubble that does not comprise ultrapure water.

In some embodiments, the aqueous compositions including ultrafine bubbles comprising or consisting essentially of water and gases released from solution in the water and dissolved/surrounded/stabilized solutes have improved bioavailability relative to naturally occurring water and dissolved solutes, and relative to compositions including ultrafine bubbles not formed via gaseous cavitation. In some embodiments, the ultrafine bubbles and dissolved/surrounded/stabilized solutes provided herein render an otherwise unavailable solute bioavailable, in which case the disclosure provides improved bioavailability of the solute relative to the undissolved/unsurrounded/unstabilized solute. In other embodiment, the ultrafine bubbles comprising or consisting essentially of water and gases released from solution in the water, wherein the ultrafine bubbles dissolve/surround/stabilize a solute improve bioavailability of the solute by about 10%, about 20%, about 30%, about 40%, about 50%, about 60%, about 70%, about 80%, or about 90% relative to the undissolved/unsurrounded/unstabilized solute. In further embodiments, the ultrafine bubbles comprising or consisting essentially of water and dissolved/surrounded/stabilized solutes improve bioavailability of the solute by about 1%, about 2%, about 3%, about 4%, about 5%, about 6%, about 7%, about 8%, or about 9%.

In some embodiments, the disclosure provides methods for improving the bioavailability of a solute, including, for example, adding the solute to water and dissolving, surrounding, and/or stabilizing the solute with ultrafine bubbles, wherein the ultrafine bubbles have a median diameter between about 2 to about 400 nanometers.

In some embodiments, the compositions having a solute dissolved/surrounded/stabilized within ultrafine bubbles comprising or consisting essentially of water and gases released from solution in the water used in the disclosed methods have improved stability relative to compositions having the undissolved/unsurrounded/unstabilized solute. In some embodiments, the solute dissolved/surrounded/stabilized by ultrafine bubbles with improved stability has an increased half-life, such as an increased solution half-life. In some embodiments, the solute dissolved/surrounded/stabilized by ultrafine bubbles comprising or consisting essentially of water and gases released from solution in the water has improved stability for extended storage periods relative to the undissolved/unsurrounded/unstabilized solute.

In some embodiments, the compositions or solutions including ultrafine bubbles comprising or consisting essentially of water and gases released from solution in the water and a solute dissolved/surrounded/stabilized within the ultrafine bubbles used in the disclosed methods have improved solubility relative to compositions or solutions including the undissolved/unstabilized/unsurrounded solute.

In some embodiments, the solute dissolved/stabilized within an ultrafine bubble normally has limited or no solubility in water but is solubilized when dissolved/stabilized in ultrafine bubbles comprising or consisting essentially of water and gases released from solution in the water. In alternative embodiments, the solute dissolved/stabilized/surrounded by ultrafine bubbles may have low to moderate solubility in water but is solubilized (e.g., completely solubilized) when dissolved/stabilized/surrounded by ultrafine bubbles comprising or consisting essentially of water and gases released from solution in the water as set forth herein.

In some embodiments, a solute of the disclosure further comprises a surface coating applied before or after dissolving/stabilizing/surrounding the solute with ultrafine bubbles comprising or consisting essentially of water and gases released from solution in the water. For biological applications, such as proteins, the surface coating may be polar to give high aqueous solubility and prevent particle aggregation.

The disclosure also provides compositions and solutions for use in agricultural applications. In particular embodiments, the compositions and solutions are for use in methods for improving bioactive potency and yield in cannabis and/or hops plants. In particular embodiments, the compositions and solutions are for use in methods for improving bioactive potency and yield in fungal species (e.g., psilocybin-producing mushrooms). In some embodiments, the disclosure provides compositions or solutions for use in fertilizer delivery, soil or plant hydration, fungal growth support, moisture retention after harvest, heat tolerance, artificial asexual propagation, or seed germination. In some embodiments, the disclosure provides compositions or solutions for use as herbicides with improved efficacy.

The present disclosure also provides methods for dissolving/surrounding/stabilizing a solute with ultrafine bubbles comprising or consisting essentially of water.

In some embodiments, the disclosure provides a process for dissolving, surrounding, and/or stabilizing a non-gaseous solute with ultrafine bubbles comprising or consisting essentially of water and gases released from solution in the water, the process comprising: selecting an amount of solute to add to a volume of water; combining the solute and water in a mixing tank to form a blended aqueous composition; pumping the blended aqueous composition at a selected flow rate through a transfer pipe from the mixing tank to a nozzle with one jet opening or a plurality of jet openings inside a hollow cylinder; using the one jet opening or the plurality of jet openings in the nozzle to jet the blended aqueous composition into the hollow cylinder; wherein the selected flow rate creates a vortex of the blended aqueous composition inside the hollow cylinder that dissolve, surround, and/or stabilizes the solutes and reduce sizes of the ultrafine bubbles in the blended aqueous composition. The process according to certain embodiments may further comprise collecting the composition comprising the solute dissolved within, surrounded by, and/or stabilized by the ultrafine bubbles; and using the reduced size ultrafine bubbles dissolving, surrounding, and/or stabilizing the solute to improve the bioavailability of the solute.

In some embodiments, a process is provided for reducing the size of ultrafine bubbles in a solution of water substantially free of dissolved non-gaseous solutes comprising pumping water at a selected flow rate through a transfer pipe to a nozzle with one jet opening or a plurality of jet openings inside a hollow cylinder; using the one jet opening or the plurality of jet openings in the nozzle to jet the blended composition into the hollow cylinder; wherein the selected flow rate creates a vortex of the blended composition inside the hollow cylinder that dissolve, surround, and/or stabilizes the solutes and reduce the size of the ultrafine bubbles in the blended composition.

In another aspect, a method for improving extraction of live rosin from cannabis is provided. The method includes combining, with cannabis flower blooms, a composition comprising water and ultrafine bubbles in accordance with the disclosure herein, and agitating the combination of the cannabis flower blooms and the composition. In some embodiments, the cannabis flower blooms are freshly harvested. In some embodiments, the method comprises freezing the cannabis flower blooms prior to combining with the composition. In some embodiments, the method further comprises filtering the agitated combination to retain trichomes of the cannabis flower blooms. In further embodiments, the method comprises collecting sediments from the filtration step, draining the sediments, and air-drying the sediments to form live rosin.

In another aspect of the invention disclosed herein, a method for producing a composition comprising water and ultrafine bubbles including gases released from solution in the water is provided. The method includes subjecting water to a combination of hydrodynamic cavitation, shear forces, and low pressure/room temperature boiling to produce ultrafine bubbles formed by release of dissolved gases from the water. In some embodiments, the water is selected from DI water, ultrapure water, tap water, groundwater (e.g., well water), surface water, and reverse osmosis water. In particular embodiments, the water is ultrapure water.

The method may comprise one or more (including all) of the following steps: adding water to a tank; pumping the water at a selected flow rate through a transfer pipe from the tank to a nozzle with one jet opening or a plurality of jet openings inside a hollow cylinder; using the one jet opening or the plurality of jet openings in the nozzle to jet the water into the hollow cylinder; wherein the selected flow rate creates a vortex of the water inside the hollow cylinder, thereby subjecting the water to a combination of hydrodynamic cavitation, shear forces, and thin film boiling to produce ultrafine bubbles formed by release of dissolved gases from the water (i.e., gaseous cavitation); collecting the composition comprising the water and ultrafine bubbles; adding a non-gaseous solute (e.g., a plant nutrient) to the composition comprising the water and ultrafine bubbles; and using the ultrafine bubbles of the composition to dissolve, surround, and/or stabilized a non-gaseous solute to improve the bioavailability of the solute.

In some embodiments, a water supply is subjected to a combination of hydrodynamic cavitation, shear forces, and low pressure/room temperature boiling to form ultrafine bubbles, and the formed ultrafine bubbles from the water supply are added to water to form the composition. In some embodiments, a water supply is subjected to processing that forms ultrafine bubbles via gaseous cavitation, and the formed ultrafine bubbles from the water supply are added to water to form a composition as set forth herein. In other embodiments, ultrafine bubbles comprising water and gases released from solution in a first water source are added to a second water source to make compositions as set forth herein. In some embodiments, a non-gaseous solute is added to the composition including the formed ultrafine bubbles and the water supply to dissolve, surround, and/or stabilize the non-gaseous solute with the formed ultrafine bubbles.

The present disclosure also provides methods for dissolving, surrounding, and/or stabilizing a non-gaseous solute with ultrafine bubbles comprising or consisting essentially of water and gases released from solution in water.

In some embodiments, the disclosure provides a process for dissolving, surrounding, and/or stabilizing a non-gaseous solute with ultrafine bubbles comprising or consisting essentially of water and gases released from solution in water, the process comprising: adding a non-gaseous solute (e.g., a plant nutrient) to a composition comprising the water and ultrafine bubbles formed by release of dissolved gases from the water; and using the ultrafine bubbles of the composition to dissolve, surround, and/or stabilized a non-gaseous solute. The process according to certain embodiments may further comprise collecting the composition comprising the non-gaseous solute dissolved within, surrounded by, and/or stabilized by the ultrafine bubbles; and using the reduced size ultrafine bubbles dissolving, surrounding, and/or stabilizing the non-gaseous solute to improve the bioavailability of the solute.

In some embodiments, the disclosure provides a process for dissolving, surrounding, and/or stabilizing a non-gaseous solute with ultrafine bubbles comprising or consisting essentially of water and gases released from solution in water, the process comprising: selecting an amount of solute to add to a volume of water; combining the solute and water in a mixing tank to form a blended aqueous composition; pumping a volume of water at a selected flow rate through a transfer pipe from the mixing tank to a nozzle with one jet opening or a plurality of jet openings inside a hollow cylinder; using the one jet opening or the plurality of jet openings in the nozzle to jet the volume of water into the hollow cylinder; wherein the selected flow rate creates a vortex of the volume of water inside the hollow cylinder that dissolve, surround, and/or stabilizes the solutes and reduce sizes of the ultrafine bubbles in the blended aqueous composition. The process according to certain embodiments may further comprise collecting the composition comprising the solute dissolved within, surrounded by, and/or stabilized by the ultrafine bubbles; and using the reduced size ultrafine bubbles dissolving, surrounding, and/or stabilizing the solute to improve the bioavailability of the solute.

In some embodiments, a process is provided for reducing the size of ultrafine bubbles in a solution of water substantially free of dissolved non-gaseous solutes comprising pumping water at a selected flow rate through a transfer pipe to a nozzle with one jet opening or a plurality of jet openings inside a hollow cylinder; using the one jet opening or the plurality of jet openings in the nozzle to jet the blended composition into the hollow cylinder; wherein the selected flow rate creates a vortex of the blended composition inside the hollow cylinder that reduces the size of the ultrafine bubbles in the blended composition.

In some embodiments of the methods, the methods further comprise concentrating the ultrafine bubbles within the composition via rotary evaporation or cross flow filtration. This disclosure is further illustrated by the following examples, which are provided to facilitate the practice of the disclosed methods. These examples do not limit the scope of the disclosure in any way.

### EXAMPLES

### Example 1: Methods of Making Compositions Including Water and Ultrafine Bubbles

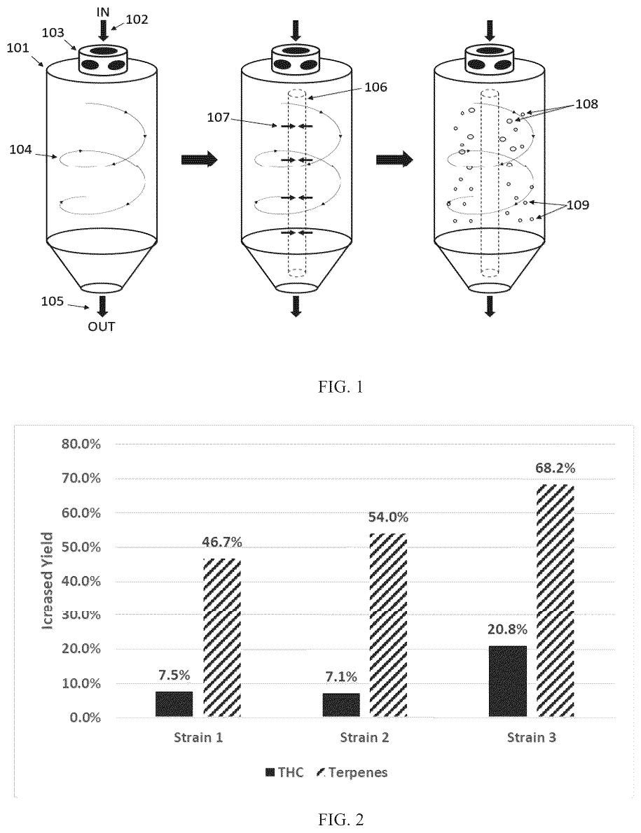

With reference to FIG. 1, a system (101) and a process for making compositions including water and ultrafine bubbles in accordance with embodiments of the invention is provided. Water enters the system (101) at step (102) via the nozzle (103) and imparts a vortex flow (104). The vortex core (106) forms as dissolved gases are drawn out of solution due to low pressure at the center (107). Without being bound by theory, it is believed micro- and ultrafine bubbles form (108) spontaneously due to low pressures near to core surface, due to gas being sheared from the core surface, and/or due to room-temperature low pressure boiling at the core surface. Shear and drag forces are believed to break the microbubbles into ultrafine bubbles resulting in a near uniform size distribution (109). The resulting composition including water and ultrafine bubbles flows from the system (101) via the exit (105).

In an embodiment of the present disclosure, a non-gaseous solute (e.g., a plant nutrient) is added to the water prior to its entry to the system 101 at step 102, and the resulting composition including water, ultrafine bubbles, and the non-gaseous solute (e.g., a plant nutrient) flows from the system (101) via the exit (105). The ultrafine bubbles of the composition dissolve, surround, and/or stabilize the non-gaseous solute.

In another embodiment of the present disclosure, a non-gaseous solute (e.g., a plant nutrient) is added to a composition including water and ultrafine bubbles after the composition exits from the system (101) via the exit (105). The ultrafine bubbles of the composition dissolve, surround, and/or stabilize the non-gaseous solute.

In another embodiment of the present disclosure, the system (101) is used to produce an ultrafine bubble suspension or composition comprising water and ultrafine bubbles. The ultrafine bubbles from the ultrafine bubble suspension or composition comprising water and ultrafine bubbles are then added to a different source of water to form a second composition. A non-gaseous solute (e.g., a plant nutrient) is the added to the second composition. The ultrafine bubbles of the second composition dissolve, surround, and/or stabilize the non-gaseous solute.

In another embodiment of the present disclosure, the water is “enriched” with microbubbles (bubbles greater than one micron and less than a millimeter in diameter) prior to entering the system (101) via the nozzle (103). These bubbles are added from an exogenous source such as a microbubble generator, venturi, or porous bubbler/membrane in-line or into a tank before processing. The resulting composition exiting via the exit (105) may have higher concentrations of ultrafine bubbles as a result (e.g., greater than 10⁸ ultrafine bubbles/mL). This is due to the breakup of the microbubbles into ultrafine bubbles while passing through the system during which, the microbubbles are exposed to drag forces. Furthermore, by creating microbubbles from specific gases, particularly gases that do not readily dissolve into water (e.g. ozone), the composition of the resulting ultrafine bubbles may be controlled or tailored to include a wider range of gases.

In another embodiment of the present disclose, the water is sparged with one or more specific gases prior to entering the system (101) via the nozzle (103). In some embodiments, the resulting composition of gases contained within the ultrafine bubbles is tailored. In some embodiments, the sparging gases may include, but not be limited to, one or more of O₂, O₃, CO₂, N₂, Ar, or any mixture containing those gases. For example, when O₂ gas and N₂ gas are sparged or bubbled in water in order to saturate the water prior to undergoing the process within system 101, the resulting composition will have a higher concentration of O₂ and N₂ ultrafine bubbles than if the water had only been exposed to the atmosphere. Such a resulting composition may have particular benefits, such as increasing plant growth upon application.

### Example 2: Cannabis Study—Impact on THC and Terpenes Yield with Exposure at Week 4 of Fruiting/Blooming Stage

Cannabis plant nutrient solutions for the fruiting/blooming stage of growth were prepared by blending a 10:20:30 Nitrogen:Phosphorus:Potassium fertilizer into conventional deionized (DI) water at about 100 mg Nitrogen, about 200 mg Phosphorus, and about 300 mg Potassium per liter of DI water (Control Treatment, using 100% of the typical concentration of nutrients used on cannabis plants at the fruiting/blooming stage of growth), or blending a 10:20:30 Nitrogen:Phosphorus:Potassium fertilizer into ultrafine bubble suspensions or compositions comprising water and ultrafine bubbles and the nutrients dissolved, surrounded, and/or stabilized with ultrafine bubbles according to the disclosure at about 50 mg Nitrogen, about 100 mg Phosphorus, and about 150 mg Potassium per liter of ultrafine bubble suspension/composition (Investigative Treatment, using 50% of the typical concentration of nutrients used on cannabis plants at the fruiting/blooming stage of the growth).

Female cannabis plants starting at four weeks into the fruiting/blooming stage of growth and through harvest were watered with approximately one gallon of Control Treatment or Investigative Treatment according to embodiments of the disclosure. At harvest, the collected flower buds revealed that the female cannabis plants exposed to nutrient water prepared according to the disclosure (Investigative Treatment) were virtually indistinguishable in terms of flower weight and terpenes and THC content—i.e., the quality was identical despite using only 50% of the nutrients of the Control Treatment plants.

### Example 3: Cannabis Study—Impact on THC and Terpenes Yield with Exposure at Week 1 of Fruiting Stage at 100% Nutrients

Cannabis plant nutrient solutions for the fruiting/blooming stage of growth were prepared by blending a 10:20:30 Nitrogen:Phosphorus:Potassium fertilizer into conventional deionized (DI) water at about 100 mg Nitrogen, about 200 mg Phosphorus, and about 300 mg Potassium per liter of DI water (Control Treatment, using 100% of the typical concentration of nutrients used on cannabis plants at the fruiting/blooming stage of growth), or blending a 10:20:30 Nitrogen:Phosphorus:Potassium fertilizer into ultrafine bubble suspensions or compositions comprising water and ultrafine bubbles and the nutrients dissolved, surrounded, and/or stabilized with ultrafine bubbles according to the disclosure at about 100 mg Nitrogen, about 200 mg Phosphorus, and about 300 mg Potassium per liter of ultrafine bubble suspension/composition (Investigative Treatment 2, using 100% of the typical concentration of nutrients used on cannabis plants at the fruiting/blooming stage of the growth).

Female cannabis plants starting at one into the fruiting/blooming stage of growth and through harvest were watered with approximately one gallon of Control Treatment or Investigative Treatment 2 according to embodiments of the disclosure. At harvest, the collected flower buds revealed that the female cannabis plants exposed to nutrient water prepared according to the disclosure (Investigative Treatment 2) had increased yield of flower buds in comparison to female cannabis plants exposed to the nutrient solutions prepared with DI water (Control Treatment). Both size and density of the flower buds harvested from the female cannabis plants exposed to the nutrient water prepared with ultrafine bubble dissolved/stabilized nutrients (Investigative Treatment 2) were increased, resulting in an increased average yield of about 2 to 10 wt % over the flower buds harvested from the female cannabis plants exposed to DI-water nutrient solution (Control Treatment). Increase in weight of flower bud harvest appeared dependent on the strain of cannabis.

At harvest, the collected flower buds revealed that the female cannabis plants exposed to nutrient water prepared according to the disclosure had increased yield of flower buds in comparison to female cannabis plants exposed to the nutrient solutions prepared with DI water (Control Treatment). Both size and density of the flower buds harvested from the female cannabis plants exposed to the nutrient water prepared with ultrafine bubble dissolved/stabilized nutrients were increased, resulting in an increased average yield of 5-10 wt % over the flower buds harvested from the female cannabis plants exposed to DI-water nutrient solution. Increase in weight of flower bud harvest appeared dependent on the strain of cannabis.

Harvested flower buds from three different strains of cannabis hybrids were also examined for THC and terpenes content and potency by weight of the flower buds. In each of the three strains, the flower buds harvested from the female cannabis plants exposed to the nutrient water prepared with ultrafine bubble dissolved/stabilized nutrients (Investigative Treatment) had higher average THC and terpenes content/potency than the flower buds harvested from the female cannabis plants exposed to DI-water nutrient solution (Control Treatment). See Tables 1-3.

TABLE 1
Average THC and Terpenes potency in Strain 1

| Ultrafine Bubble Prepared | | | |
|---|---|---|---|
| Nutrient Solution (H) | | Potency of | Potency of |
| [Investigative Treatment] | | THC by | Terpenes by |
| or Deionized Water | | Weight | Weight |
| Prepared Nutrient Solution | Plant | Percentage of | Percentage of |
| (DI) [Control Treatment] | ID No. | Flower Buds | Flower Buds |
| DI | 220430 | 28.90% | 3.23% |
| DI | 220513 | 24.40% | 2.54% |
| DI | 220520 | 30.32% | 3.44% |
| DI | 220603 | 31.05% | 3.00% |
| DI | 220624 | 31.01% | 3.31% |
| DI | 220708 | 24.59% | 3.40% |
| DI | 220810-01 | 32.49% | 3.53% |
| DI | 220825 | 28.42% | 3.48% |
| DI | 221103 | 29.93% | 3.33% |
| DI | 230124 | 31.86% | 3.00% |
| H | 230320 | 32.57% | 5.00% |
| H | 230418-1 | 30.42% | 4.48% |
| DI | 230418-2 | 31.90% | 4.90% |

For Strain 1, the average THC content/potency in flower buds harvested from the female cannabis plants exposed to the nutrient water prepared with ultrafine bubble dissolved/stabilized nutrients (Investigative Treatment) was, on average, about 7.5% higher by weight over the THC content/potency of flower buds harvested from the female cannabis plants exposed to DI-water nutrient solution (Control Treatment). For Strain 1, the average terpenes content/potency in flower buds harvested from the female cannabis plants exposed to the nutrient water prepared with ultrafine bubble dissolved/stabilized nutrients (Investigative Treatment) was, on average, about 47% higher by weight over the terpenes content/potency of flower buds harvested from the female cannabis plants exposed to DI-water nutrient solution.

TABLE 2
Average THC and Terpenes potency in Strain 2

| Ultrafine Bubble Prepared | | | |
|---|---|---|---|
| Nutrient Solution (H) | | Potency of | Potency of |
| [Investigative Treatment] | | THC by | Terpenes by |
| or Deionized Water | | Weight | Weight |
| Prepared Nutrient Solution | Plant | Percentage of | Percentage of |
| (DI) [Control Treatment] | ID No. | Flower Buds | Flower Buds |
| DI | 220914 | 28.94% | 2.43% |
| DI | 221114 | 22.95% | 1.68% |
| DI | 221205 | 24.43% | 2.40% |
| DI | 230116 | 27.37% | 2.10% |
| H | 230303 | 26.93% | 2.99% |
| H | 230403 | 29.67% | 3.60% |
| H | 230425 | 26.64% | 3.33% |

For Strain 2, the average THC content/potency in flower buds harvested from the female cannabis plants exposed to the nutrient water prepared with ultrafine bubble dissolved/stabilized nutrients (Investigative Treatment) was, on average, about 7.1% higher by weight over the THC content/potency of flower buds harvested from the female cannabis plants exposed to DI-water nutrient solution (Control Treatment). For Strain 2, the average terpenes content/potency in flower buds harvested from the female cannabis plants exposed to the nutrient water prepared with ultrafine bubble dissolved/stabilized nutrients (Investigative Treatment) was, on average, about 54% higher by weight over the terpenes content/potency of flower buds harvested from the female cannabis plants exposed to DI-water nutrient solution.

TABLE 3
Average THC and Terpenes potency in Strain 3

| Ultrafine Bubble Prepared | | | |
|---|---|---|---|
| Nutrient Solution (H) | | Potency of | Potency of |
| [Investigative Treatment] | | THC by | Terpenes by |
| or Deionized Water | | Weight | Weight |
| Prepared Nutrient Solution | Plant | Percentage of | Percentage of |
| (DI) [Control Treatment] | ID No. | Flower Buds | Flower Buds |
| DI | 220731 | 24.59% | 3.43% |
| DI | 221006 | 21.22% | 1.44% |
| DI | 221114 | 22.01% | 3.06% |
| H | 230403 | 27.32% | 4.44% |

For Strain 3, the average THC content/potency in flower buds harvested from the female cannabis plants exposed to the nutrient water prepared with ultrafine bubble dissolved/stabilized nutrients (Investigative Treatment) was, on average, about 21% higher by weight over the THC content/potency of flower buds harvested from the female cannabis plants exposed to DI-water nutrient solution (Control Treatment). For Strain 3, the average terpenes content/potency in flower buds harvested from the female cannabis plants exposed to the nutrient water prepared with ultrafine bubble dissolved/stabilized nutrients (Investigative Treatment) was, on average, about 68% higher by weight over the terpenes content/potency of flower buds harvested from the female cannabis plants exposed to DI-water nutrient solution. A graphical representation of the increase in THC and terpenes in the three strains is also shown in FIG. 2.

### Example 4: Cannabis Study—Impact on THC Yield with Exposure from Propagation Through Fruiting Stage

Cannabis plant nutrient solutions for propagation, vegetative, and fruiting/blooming stages of growth were prepared. The nutrient solution for the propagation stage was prepared by blending a 15:5:10 ratio Nitrogen:Phosphorus:Potassium fertilizer into ultrafine bubble suspensions or compositions comprising water and ultrafine bubbles according to the disclosure herein and the nutrients dissolved, surrounded, and/or stabilized with ultrafine bubbles according to the disclosure at about 75 mg Nitrogen, about 25 mg Phosphorus, and about 50 mg Potassium per liter of ultrafine bubble suspension/composition (Propagation Treatment 1, using 50% of the typical concentration of nutrients used on cannabis plants at the propagation stage of the growth).

The nutrient solutions for the vegetative stage were prepared by blending a 20:10:10 Nitrogen:Phosphorus:Potassium fertilizer into ultrafine bubble suspensions or compositions comprising water and ultrafine bubbles according to the disclosure herein and the nutrients dissolved, surrounded, and/or stabilized with ultrafine bubbles according to the disclosure at about 100 mg Nitrogen, about 50 mg Phosphorus, and about 50 mg Potassium per liter of ultrafine bubble suspension/composition (Vegetative Treatment 1, using 50% of the typical concentration of nutrients used on cannabis plants at the vegetative stage of the growth), or blending a 20:10:10 Nitrogen:Phosphorus:Potassium fertilizer into ultrafine bubble suspensions or compositions comprising water and ultrafine bubbles according to the disclosure herein, and the nutrients dissolved, surrounded, and/or stabilized with ultrafine bubbles according to the disclosure at about 200 mg Nitrogen, about 100 mg Phosphorus, and about 100 mg Potassium per liter of ultrafine bubble suspension/composition (Vegetative Treatment 2, using 100% of the typical concentration of nutrients used on cannabis plants at the vegetative stage of the growth).

The nutrient solutions for the fruiting/blooming stage were prepared by blending a 10:20:30 Nitrogen:Phosphorus:Potassium fertilizer into ultrafine bubble suspensions or compositions comprising water and ultrafine bubbles according to the disclosure herein and the nutrients dissolved, surrounded, and/or stabilized with ultrafine bubbles according to the disclosure at about 50 mg Nitrogen, about 100 mg Phosphorus, and about 150 mg Potassium per liter of DI water (Fruiting Treatment 1, using 50% of the typical concentration of nutrients used on cannabis plants at the fruiting/blooming stage of growth), or blending a 10:20:30 Nitrogen:Phosphorus:Potassium fertilizer into ultrafine bubble suspensions or compositions comprising water and ultrafine bubbles and the nutrients dissolved, surrounded, and/or stabilized with ultrafine bubbles according to the disclosure at about 100 mg Nitrogen, about 200 mg Phosphorus, and about 300 mg Potassium per liter of ultrafine bubble suspension/composition (Fruiting Treatment 2, using 100% of the typical concentration of nutrients used on cannabis plants at the fruiting/blooming stage of the growth).

Female cannabis plants during propagation/rooting were watered with 0.2 gallons of Propagation Treatment 1 per clonal cultivar per day. Upon reaching the vegetative stage, the female cannabis plants were switched to about 0.35 gallon of Vegetative Treatment 1 per plant per day until the final week of vegetation, at which point the plants were switched to about 0.35 gallon of Vegetative Treatment 2 per plant per day. During the first week of fruiting/blooming, the female cannabis plants were watered with about 1 gallon of Fruiting Treatment 1 per plant per day, then switched at week 2 through week 9 of fruiting to about 1 gallon of Fruiting Treatment 2 per plant per day. After week 9, the plants were harvested. At harvest, the collected flower buds revealed that the female cannabis plants exposed to nutrient water prepared according to the disclosure throughout the growth cycle from rooting/propagation to flowering produced flower buds with an average increase in THC content/potency of 11% over the content/potency of THC in the plants treated with DI water. The flower buds also revealed that the female cannabis plants exposed to nutrient water prepared according to the disclosure throughout the growth cycle from rooting/propagation to flowering produced flower buds with an average increase in terpenes content/potency of 56% over the content/potency of terpenes in the plants treated with DI water.

### Example 5: Reduction of Clonal Die-Off in Propagated Cannabis Plants

Two sets of clonal cannabis cuttings were prepared and propagated using the rockwool cube soak method. Both sets were cut, then subjected to soaking to form roots. The first set was soaked for rooting in ordinary tap water, while the second set was soaked for rooting in an ultrafine bubble composition comprising water and ultrafine bubbles prepared in accordance with the disclosure herein. The first set of clones soaked in ordinary tap water experienced a die-off of about 15-25%. However, the second set of clones soaked in the ultrafine bubble composition only experienced a die-off of between 5-15%.

### Example 6: Improved Survivability in Propagated Cannabis Plants

Cannabis plant nutrient solutions for the propagation stage of growth were prepared. The nutrient solutions for the propagation stage were prepared by blending a 15:5:10 ratio Nitrogen:Phosphorus:Potassium fertilizer into ultrafine bubble suspensions or compositions comprising water and ultrafine bubbles according to the disclosure herein and the nutrients dissolved, surrounded, and/or stabilized with ultrafine bubbles according to the disclosure at about 75 mg Nitrogen, about 25 mg Phosphorus, and about 50 mg Potassium per liter of ultrafine bubble suspension/composition (Propagation Treatment 2, using 50% of the typical concentration of nutrients used on cannabis plants at the propagation stage of the growth), or blending a 15:5:10 ratio N:P:K fertilizer into conventional deionized (DI) water at about 75 mg Nitrogen, about 25 mg Phosphorus, and about 50 mg Potassium per liter of DI water (Control Treatment, using 50% of the typical concentration of nutrients used on cannabis plants at the fruiting/blooming stage of growth).

Female cannabis clones during propagation/rooting were watered with 0.2 gallons of either Propagation Treatment 2 or Control Treatment per clonal cultivar per day for two weeks. The plants were then transplanted into organic soil after growing root strikes for the two weeks of propagation. The cannabis plants watered with the Propagation Treatment 2 experienced little transplantation shock and began to grow normally during the vegetative phase in the soil. However, the cannabis plants water with the Control Treatment during rooting experienced significant transplantation shock due to nutrient deficiency, and died during the vegetative stage.

### Example 7: Cannabis Rooting Experiment

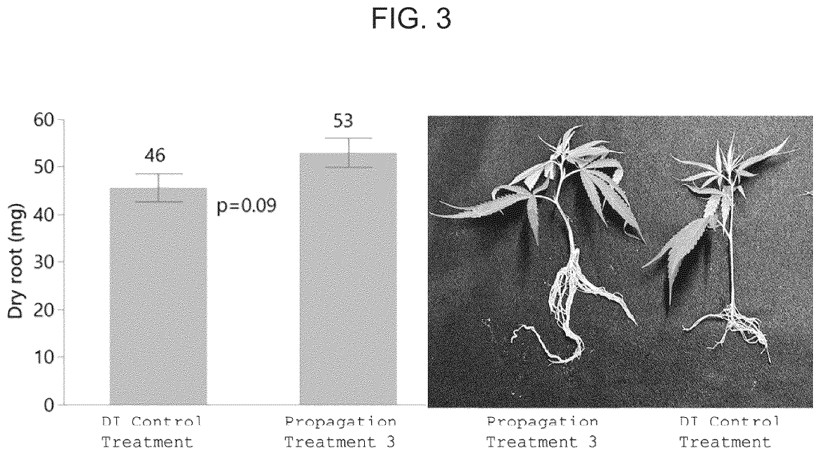

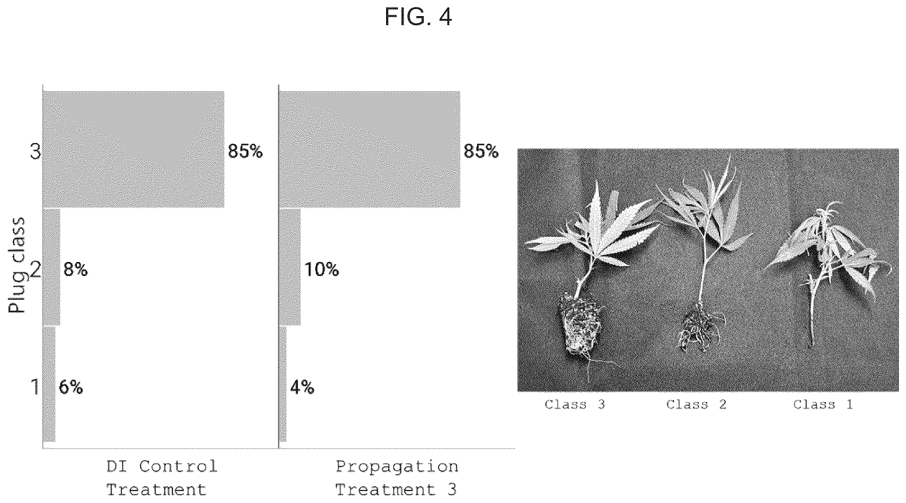

Two sets of 24 cannabis cuttings were dipped in gel of 0.31% IBA before being planted in a peat-based propagation mix soaked in either a DI-based fertilizer solution (DI Control Treatment) or a fertilizer solution prepared by mixing the fertilizer into ultrafine bubble suspensions or compositions comprising water and ultrafine bubbles according to the disclosure herein and the fertilizer dissolved, surrounded, and/or stabilized with ultrafine bubbles according to the disclosure (Propagation Treatment 3). Each cutting was placed in a removable cell in the plug trays for irrigation and randomization. Plants were harvested and evaluated after 13 days in the propagation chamber at which point the roots were examined and weighed. The average dry root mass was found to be 15.2% greater for those plants treated with the ultrafine bubble composition (FIG. 3). Furthermore, the plants treated with the ultrafine bubble composition were found to be more developed by root plug “class”—i.e., a larger proportion of the plants treated with the Propagation Treatment 3 were in root plug classes 2 and 3 in comparison to the plants treated with the DI Control Treatment—and fewer were found to be at the lower end of the mass distribution (FIG. 4).

### Example 8: Herbicide Study on Native Grass Lawn with Broadleaf Weeds

The efficacy and increase in efficiency of herbicide application was compared between compositions prepared with herbicidal agents in accordance with this disclosure and herbicidal compositions prepared using conventional tap water. A commercially available lawncare herbicide labeled as a grass and weed killer in concentrated liquid form was used for this comparison.

The active ingredients of the herbicide were: Diquat dibromide 2.39%, Fluazifop-p-butyl 1.15%, Dicamba, Dimethylamine salt 0.77%, with other non-herbicidal ingredients making up the other 95.78% for a total of 100%.

Six (6) fl. oz of the concentrated herbicidal composition were added per gallon of tap water to create a 100% recommended use rate “Control 100%” composition (which treats approximately 300 sq ft of lawn per gallon).

Three (3) fl. oz of the concentrated herbicidal composition were added per gallon of tap water to create a 50% recommended use rate “Control 50%” composition.

Three (3) fl. oz of the concentrated herbicidal composition were added per gallon of ultrafine bubble composition comprising water and ultrafine bubbles prepared in accordance with the disclosure herein to create a 50% recommended use rate “Investigative 50%” composition.

Two (2) fl. oz of the concentrated herbicidal composition were added per gallon of ultrafine bubble composition comprising water and ultrafine bubbles prepared in accordance with the disclosure herein to create a 33% recommended use rate “Investigative 33%” composition.

### Treatments

Four plots of lawn from the same location containing native grass lawn and broadleaf weeds were used for each of the test compositions. As each plot was 150 sq ft, 0.5 gallon of each treatment solution was used to treat the respective plots. The 0.5 gallon of each respective treatment was sprayed onto the pertinent plot.
Treatment 1—Control: tap water with the 100% recommended herbicide dose rate (“Control 100%”)
Treatment 2—tap water with 50% of the recommended herbicide dose rate (“Control 50%”)
Treatment 3—ultrafine bubble composition comprising water and ultrafine bubbles prepared in accordance with the disclosure herein with 50% of the recommended herbicide dose rate (“Investigative 50%”)
Treatment 4—ultrafine bubble composition comprising water and ultrafine bubbles prepared in accordance with the disclosure herein with 33% of the recommended herbicide dose rate (“Investigative 33%”)

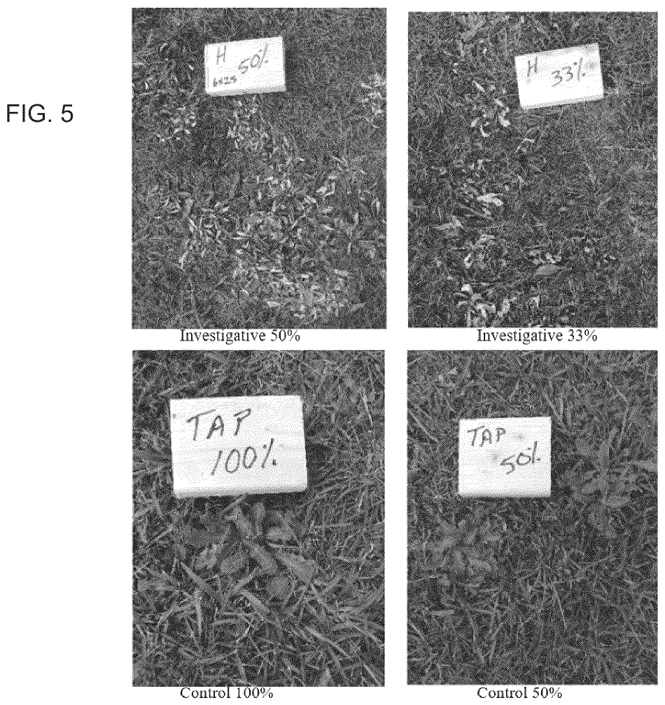

All four plots with their respective treatments were observed 80 minutes post-application. Only Treatments 3 and 4 demonstrated deterioration of the grass and weeds in their respective plots (“Investigative 50%” and “Investigative 33%” Treatments), with the tips of the grasses and weeds beginning to bleach and whiten. Neither of the plots treated with Treatments 1 and 2 exhibited any signs of deterioration. See FIG. 5.

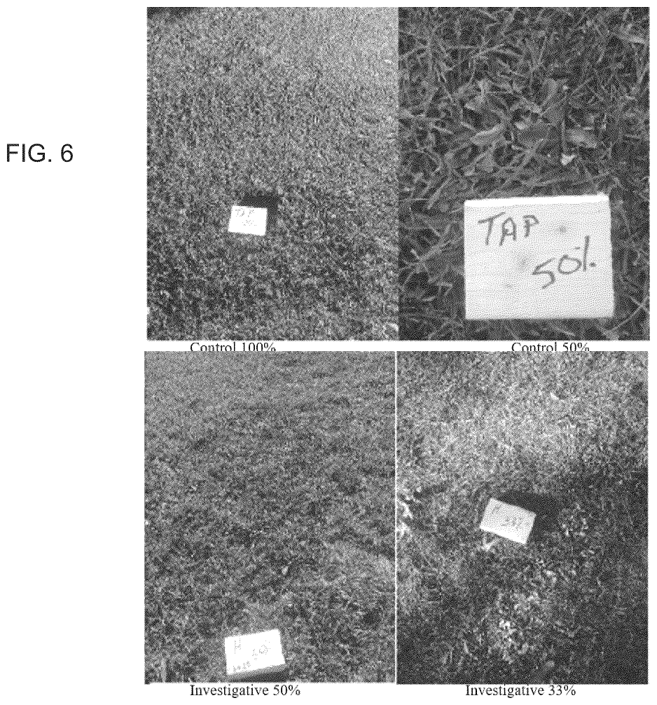

The four plots were then observed 25 hours post-application of the respective treatments. Treatment 1 (“Control 100%”) demonstrated efficacy in killing both the native grasses and broadleaf weeds, while Treatment 2 (“Control 50%) showed only minimal damage to the broadleaf weeds and no damage to grasses. However, both Treatments 3 and 4 (“Investigative 50%” and “Investigative 33%” Treatments) demonstrated high efficacy in killing both broadleaf and grassy weeds of all varieties. See FIG. 6.

### Example 9: Fungal Growth Study on Yeast

The effect on growth of yeast (i.e., single-celled fungi) was compared between yeast growth media compositions prepared in accordance with this disclosure and yeast growth media compositions prepared using conventional DI water. 50 grams of yeast peptone dextrose (YPD) broth was mixed with 1 liter of DI water for the comparative treatment and with 1 liter of water prepared in accordance with the disclosure herein for the investigational treatment. The pH for both mixtures was adjusted to between 3.6-3.7. Each treatment was added to three 25 mL flasks to yield 6 experimental flasks. Additionally, two more control flasks were prepared, one with 25 mL DI water/YPD and one with 25 mL water prepared in accordance with the disclosure/YPD.

A sorbic acid stock solution at 50 g/L was also prepared. Sorbate solutions were added to the 6 experimental flasks as follows (and see Table 4 for experimental setup):
50 mg/L: 25 uL/25 mL (1 flask with YPD and DI water, 1 flask with YPD and water prepared in accordance with disclosure)
100 mg/L: 50 uL/25 mL (1 flask with YPD and DI water, 1 flask with YPD and water prepared in accordance with disclosure)
300 mg/L: 150 uL/25 mL (1 flask with YPD and DI water, 1 flask with YPD and water prepared in accordance with disclosure)

TABLE 4
Experimental setup for yeast growth study

| Treatment | Deionized Water | | | | Water Prepared in Accordance with Disclosure | | | |
|---|---|---|---|---|---|---|---|---|
| Sorbic | 0 mg/L | 50 mg/L | 100 mg/L | 300 mg/L | 0 mg/L | 50 mg/L | 100 mg/L | 300 mg/L |
| Acid Level | (Control) | | | | (Control) | | | |
| Code | DI-0 | DI-50 | DI-100 | DI-300 | HW-0 | HW-50 | HW-100 | HW-300 |

S. cerevisiae yeast cells (EC1118, Lalvin) were rehydrated by adding 2.0 g of dry yeast to 20 mL of either DI water or water prepared in accordance with the disclosure. The equivalent of 50 uL/25 mL of the yeast cell preparation was added to each of the 6 experimental flasks and to the 2 control flasks. The flasks were incubated at 25 C for 24 hours.

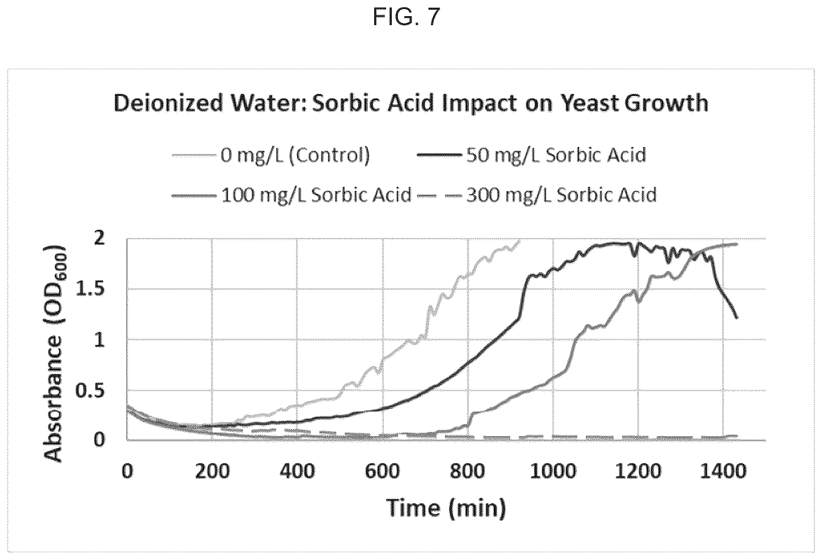

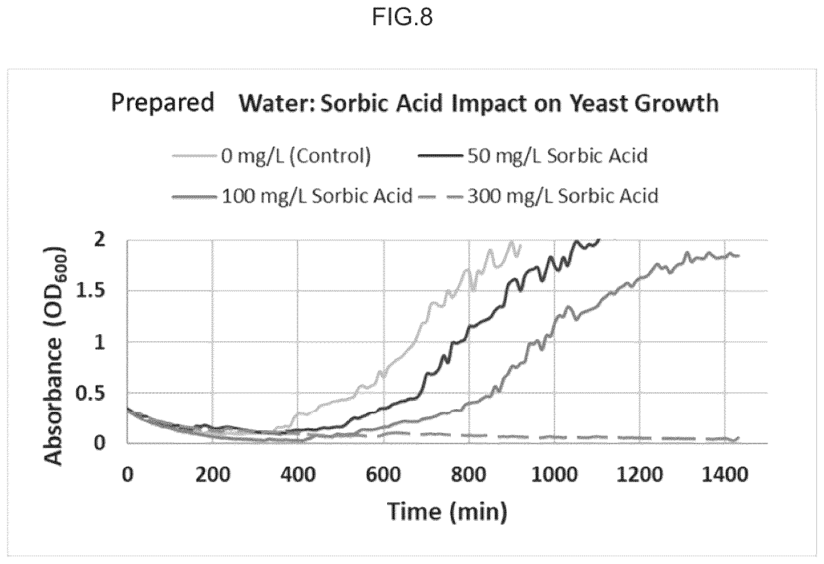

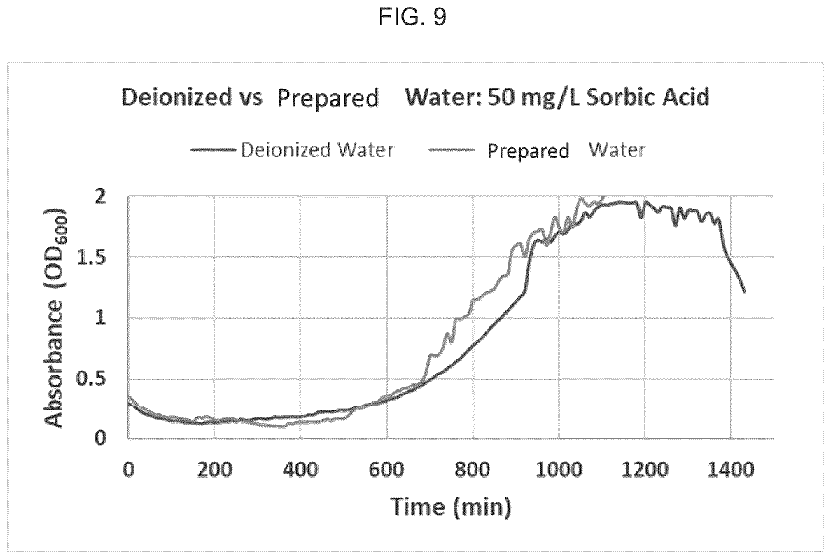

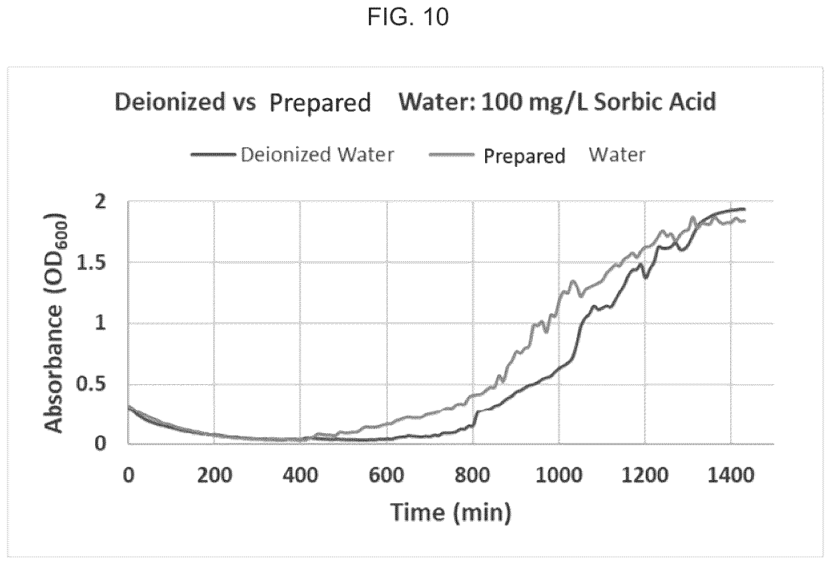

Growth of the yeast cells in each of the flasks was observed using optical density measurements. The optical density/turbidity of yeast cells was measured in each flask every ten minutes for 24 hours (absorbance measured in OD600). FIG. 7 depicts the impact of different sorbic acid concentrations on yeast growth in the deionized water flasks (both experimental and control shown). FIG. 8 depicts the impact of different sorbic acid concentrations on yeast growth in the flasks containing the water prepared in accordance with the disclosure herein (‘Prepared Water”). FIG. 9 depicts a comparison of yeast growth under the influence of 50 mg/L sorbic acid in YPD media mixtures made with DI water versus water prepared in accordance with the disclosure herein (“Prepared Water”). FIG. 10 depicts a comparison of yeast growth under the influence of 100 mg/L sorbic acid in YPD media mixtures made with DI water versus water prepared in accordance with the disclosure herein (“Prepared Water”).

The application of stress in the form of lower pH (pH 3.6) and the antifungal agent, sorbic acid, highlights differences in the growth kinetics of S. cerevisiae yeast cells when the growth media is prepared with deionized water compared to water prepared in accordance with the disclosure. At 50 mg/L and 100 mg/L sorbic acid, S. cerevisiae grown in YPD media made with the “Prepared Water” showed stronger growth kinetics as compared to YPD media made with deionized water. This phenomenon is observed during the exponential phase of growth where “Prepared Water” treated cell concentrations (quantified by absorbance at 600 nm) rise more quickly and rapidly compared to the deionized water treatment. These findings are contrary to the hypothesis of this study that presumed yeast growth may be decreased due to the “Prepared Water” increasing the amount of sorbic acid getting into the cell, thus increasing its inhibitory effects. Thus, the findings may indicate the “Prepared Water” has the ability to increase cellular growth/performance of fungal cells even under sub-optimal/stressful conditions.

### Example 10: Leafy Greens Wilting Experiment

The experiment aimed to evaluate the effects of ultrafine bubble suspensions on delaying the wilting process in leafy greens, specifically lettuce leaves. By comparing the rate of wilting between leaves soaked in ultrafine bubble suspension (test group) and those soaked in deionized water (control group), the study sought to demonstrate the potential of ultrafine bubble technology in preserving the freshness and longevity of leafy vegetables.

### Summary of Experiment

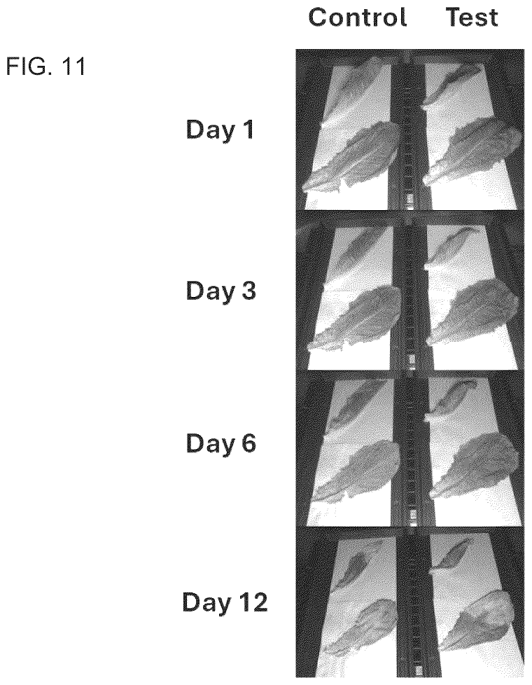

Lettuce leaves of comparable size and condition were selected for the study. The leaves were divided into two groups: one group was soaked in deionized water (control), and the other was soaked in an ultrafine bubble suspension (test). Both groups were soaked for 12 hours at room temperature. Following the soaking period, the leaves were removed, lightly patted dry, and placed in a controlled environment to observe the natural wilting process. The temperature, humidity, and air circulation within the environment were kept consistent throughout the experiment. The leaves were not watered during the observation period, which lasted 15 days. Photographic documentation of the leaves was taken on Day 1, Day 3, Day 6, and Day 12 to visually track the progression of wilting (FIG. 11). The physical condition of the leaves, including volume, flexibility, and mass retention, was monitored and compared between the control and test groups.

### Results

Day 1: Both control and test leaves appeared similar, with no noticeable signs of wilting.
Day 3: The control leaves began to show slight signs of wilting, while the test leaves remained largely unchanged.
Day 6: Wilting became more pronounced in the control leaves, with a visible reduction in volume and flexibility. The test leaves maintained their volume and flexibility to a greater extent.
Day 10: The control leaves exhibited advanced wilting, becoming dry and brittle. In contrast, the test leaves retained their shape, color, and mass to a significant degree.

### Example 11: Mycelium Fermentation Experiment

An experiment was conducted to evaluate the effect of ultrafine bubble suspension on the growth of filamentous fungi in a complex medium. The fermentation was carried out in shaker flasks, and the biomass produced was measured via dry cell mass.

### Summary of Experiment

The experiment compared the biomass produced using two different types of water in the media: deionized (DI) water, which served as the control, and ultrafine bubble suspension, which was the test condition.

### Results

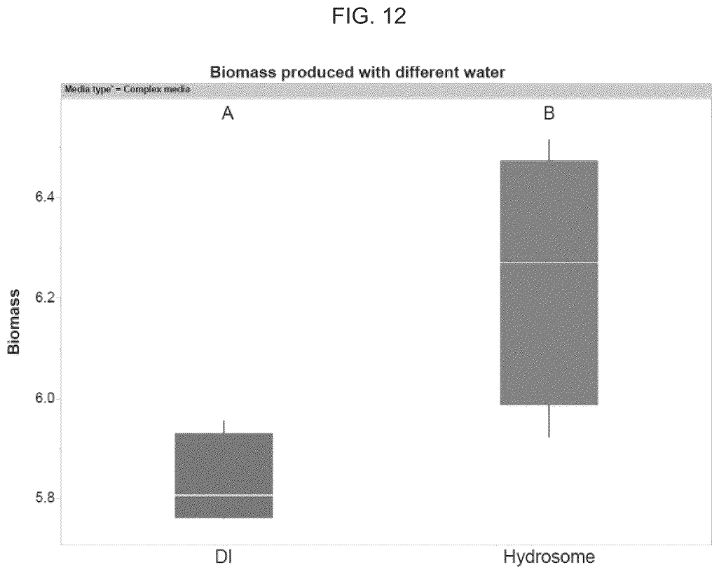

The results are illustrated in FIG. 12, which shows a box plot comparing the final biomass levels between the two conditions.

Control (DI Water): The fungi grown in the medium with DI water produced a biomass ranging between approximately 5.8 and 6.0 units, with a relatively narrow interquartile range, indicating consistent growth across replicates.

Test: The use of ultrafine bubble suspension resulted in a statistically significant increase in biomass production, with values ranging from approximately 6.0 to 6.4 units. The interquartile range is broader compared to the control, suggesting some variability, but with consistently higher biomass levels than those observed in the DI water condition.

The analysis shows using the ultrafine bubble suspension consistently outperformed the DI water, with the median biomass level in the ultrafine bubble suspension group being higher than the maximum biomass observed in the DI water group as shown in FIG. 12.

### Example 12: Cannabis Rooting Study

The cannabis rooting study conducted by North Carolina State University (NCSU) explored the effectiveness of ultrafine bubble suspensions in promoting root growth in cannabis cuttings.

### Summary of Experiment

Treatments: The experiment involved two treatments: Ultrafine bubble suspension water and DI water: Deionized water used as a control.

Cuttings: A total of 48 cannabis cuttings per treatment were used. Each cutting was dipped in a rooting gel containing 0.31% Indole-3-butyric acid (IBA) to stimulate rooting.

Propagation Medium: Cuttings were planted in a peat-based propagation mix (Sunshine SS LA4 RSI) consisting of 65-75% Canadian sphagnum peat moss, perlite, dolomite limestone, and a wetting agent. The propagation mix was hydrated with either ultrafine bubble suspension water or DI water before planting.

Propagation Conditions and Chamber Environment: The experiment was conducted in a controlled propagation chamber with precise environmental settings as follows:
Day Temperature: 27.6° C.±1.1° C.
Night Temperature: 25.9° C.±0.7° C.
Day Relative Humidity: 99.4%±0.6%
Night Relative Humidity: 99.9%±0.2%
Photoperiod: 18 hours of light per day
Light Intensity: 158.13 μmol/m²/s
CO2 Levels: 530 ppm±132 (daytime inside chamber)

Duration: Cuttings were maintained under these conditions for 13 days.

Evaluation: Root mass and root plug quality were the primary metrics for evaluating the effectiveness of the treatments. The root mass of each cutting was measured after 13 days, and root plugs were classified into different categories based on the size and quality of root development.

### Results

Enhanced Root Growth: Cannabis cuttings treated with ultrafine bubble suspension water exhibited a significantly higher root mass (57 mg) compared to those treated with DI water (22 mg), indicating a substantial improvement in rooting.

Superior Root Plug Quality: The cuttings treated with ultrafine bubble suspension water had a higher percentage of larger and more developed root plugs, essential for strong plant establishment.

Optimized Propagation Process: ultrafine bubble suspensions in the propagation medium led to quicker and more robust root formation, enhancing the efficiency and success rate of the propagation process.

While the present disclosure has been described and illustrated herein by references to various specific materials, procedures and examples, it is understood that the disclosure is not restricted to the particular combinations of materials and procedures selected for that purpose. Numerous variations of such details can be implied as will be appreciated by those skilled in the art. It is intended that the specification and examples be considered as exemplary only, with the true scope and spirit of the disclosure being indicated by the following claims.

1. A composition for increasing a bioactive compound yield of a plant, the composition comprising:
water;
ultrafine bubbles; and
at least one non-gaseous solute selected from the group consisting of: nitrogen, phosphorous, potassium, calcium, magnesium, ammonium, sulfur, copper, iron, manganese, molybdenum, zinc, boron, silicon, cobalt, vanadium, and urea,
wherein the at least one non-gaseous solute is dissolved within, surrounded by, and/or stabilized by the ultrafine bubbles.

2. The composition of claim 1, wherein the composition increases cell permeability and/or bioavailability of the at least one non-gaseous solute.

3. The composition of claim 1, wherein the at least one non-gaseous solute is present at a concentration of at least 0.1 mg/L of composition.

4. The composition of claim 1, wherein the ultrafine bubbles have a median diameter of between 2-400 nanometers

5. The composition of claim 1, wherein the plant is one or more of an actively growing female cannabis and/or hops plants.

6. The composition of claim 1, wherein the bioactive compound includes one or more of a cannabinoid and a terpene from a cannabis and/or hops plant.

7. A method for increasing bioactive compound yield of cannabis and/or hops plant blooms, the method comprising:
providing the composition of claim 1;
applying the composition to a growing female cannabis or hops plant.

8. The method according to claim 7, wherein roots of the growing female cannabis or hops wherein the bioactive compound yield is increased by at least 2 wt % in cannabis or hops plant blooms yielded by the growing female cannabis or hops plant to which the composition was applied as compared to cannabis or hops plant blooms yielded by a growing female cannabis or hops plant of the same strain to which the composition was not applied.

9. A composition for improving efficacy of herbicidal agents for application on unwanted plants, the composition comprising:
water;
ultrafine bubbles; and
at least one non-gaseous solute, wherein the at least one non-gaseous solute comprises one or more herbicidal agents or compounds; and,
wherein the at least one non-gaseous solute is dissolved within, surrounded by, and/or stabilized by the ultrafine bubbles.

10. The composition of claim 9, wherein the composition increases cell permeability and/or bioavailability of the at least one dissolved non-gaseous solute.

11. The composition of claim 10, wherein the at least one solute comprises one or more of diquat dibromide, fluazifop-p-butyl, dicamba, dimethylamine salt, 2,4-D, dimethylamine salt, mecoprop-p, dimethylamine salt, glyphosate, and sulfentrazone.

12. A method for increasing herbicidal efficacy, the method comprising:
providing the composition of claim 9; and,
applying the composition to unwanted plants.

13. The method according to claim 12, wherein herbicidal efficacy of the composition is increased by at least 30% in comparison to the herbicidal efficacy of herbicidal compositions having the same concentration of herbicidal agents and/or compounds but not prepared in accordance with the process.

14. A composition for increasing water retention and/or reducing wilting of harvested plant materials, the composition comprising:
water;
ultrafine bubbles;
at least one non-gaseous solute, wherein the at least one non-gaseous solute comprises an ethylene inhibitor, nitrogen, phosphorous, potassium, calcium, magnesium, ammonium, sulfur, copper, iron, manganese, molybdenum, zinc, boron, silicon, cobalt, vanadium, or urea; and,
wherein the at least one non-gaseous solute is dissolved within, surrounded by, and/or stabilized by the ultrafine bubbles.

15. The composition of claim 14, wherein the composition increases cell permeability and/or bioavailability of the at least one dissolved non-gaseous solute.

16. A method for increasing water retention and/or reducing wilting of harvested plant materials, the method comprising:
providing the composition of claim 14;
applying the composition to harvested plants.

17. The method according to claim 16, wherein the harvested plants absorb the one or more solutes dissolved and/or stabilized with the ultrafine bubbles more efficiently as compared to a composition not prepared by the process.
